(19) United States
(12) Patent Application Publication
(10) Pub. No.: US 2020/0070534 A1
(43) Pub. Date: Mar. 5, 2020

(54) LIQUID CONTAINER, LIQUID CONSUMPTION DEVICE, AND METHOD OF CONTROLLING THE SAME

(71) Applicant: SEIKO EPSON CORPORATION, Tokyo (JP)

(72) Inventors: Taku ISHIZAWA, Matsumoto-shi (JP); Noriyuki FUKASAWA, Matsumoto-shi (JP); Shuichi KOGANEHIRA, Matsumoto-shi (JP); Takayuki YAZAWA, Shiojiri-shi (JP)

(73) Assignee: SEIKO EPSON CORPORATION, Tokyo (JP)

(21) Appl. No.: 16/554,328

(22) Filed: Aug. 28, 2019

(30) Foreign Application Priority Data
Aug. 31, 2018 (JP) 2018-162414

(51) Int. Cl. B41J 2/175; G01F 23/292

(52) U.S. Cl. CPC B41J 2/17566; B41J 2002/17573; G01F 23/2922; B41J 2/1752

(57) ABSTRACT

A liquid container is used in a liquid consumption device including a mounting unit to which a liquid container provided with a prism at a predetermined site, and a liquid container not provided with a prism at the predetermined site are replaceably mounted; a light emitting unit that emits light to the predetermined site of the liquid container; and a light receiving unit that receives light reflected from the predetermined site. The liquid container is not provided with the prism, and is provided with a reflection reduction unit that reduces reflection of light to the light receiving unit, at the predetermined site.

The present application is based on, and claims priority from JP Application Serial Number 2018-162414, filed Aug. 31, 2018, the disclosure of which is hereby incorporated by reference herein in its entirety.

### BACKGROUND

### 1. Technical Field

The present disclosure relates to a liquid container, a liquid consumption device, and a method of controlling the liquid consumption device.

### 2. Related Art

An existing technique detects liquid using an optical unit, the liquid remaining in a liquid container which stores liquid (JP-A-2003-260804). In the technique of JP-A-2003-260804, an ink tank has a prism on one surface inside the main body of the ink tank. Light emitted from an external red LED light source to the prism travels through the prism in a straight line, and reaches the interface with the ink. When the prism is immersed in ink, light travels through the ink because the difference between the refractive indexes of the prism and the ink is small. On the other hand, when the prism is exposed to air inside the main body of the ink tank, light is totally reflected by the interface between the prism and air because the difference between the refractive indexes of air and the prism is large. The reflection light is incident to a CCD monochrome area sensor as a light receiving unit. Consequently, it is detected that there is no ink in the ink tank.

As described above, in a printer that detects the remaining amount of ink by an optical unit, when light from a site other than the prism reaches a light receiving unit, accurate determination may not be made. If it is determined that ink remains in the ink tank, and the head is driven in the state although no ink remains in the ink tank, a failure of the head may be caused.

An ink tank also exists, which is not provided with a prism for reflecting incident light from the outside to a light receiving unit. In such an ink tank, it is not possible to determine nor manage the remaining amount of ink by the optical unit as described in JP-A-2003-260804.

### SUMMARY

According to an embodiment of the present disclosure, a liquid container is provided. The liquid container is used in a liquid consumption device including a mounting unit replaceably mountable with: a liquid container provided with a prism at a predetermined site and a liquid container not provided with a prism at the predetermined site; a light emitting unit that emits light to the predetermined site of the liquid container; and a light receiving unit that receives light reflected from the predetermined site. The liquid container is a liquid container in which the prism is not provided.

### BRIEF DESCRIPTION OF THE DRAWINGS

FIG. 1 is a perspective view illustrating the substantial part of a printing device in this embodiment.

FIG. 2 is an external appearance perspective view of an ink cartridge illustrating a front face, a top face, and a right face of a first type ink cartridge provided with a prism.

FIG. 3 is an external appearance perspective view of the ink cartridge illustrating a rear face, a bottom face, and a left face of the ink cartridge.

FIG. 4 is an external appearance perspective view of the ink cartridge illustrating the left face, the bottom face, and the front face of the ink cartridge.

FIG. 5 is an external appearance perspective view, as seen from the bottom face, of a first member unit disposed in the bottom face of the ink cartridge.

FIG. 6 is an external appearance perspective view of the first member unit as seen from the top face of the ink cartridge.

FIG. 7 is a VII-VII cross-sectional view of FIG. 6.

FIG. 8 is an external appearance perspective view of a second type ink cartridge provided with a reflection reduction unit.

FIG. 9 is an external appearance perspective view, as seen from the bottom face, of a second member unit disposed in the bottom face of the ink cartridge.

FIG. 10 is an explanatory diagram illustrating a relationship between a holder and the prism or the reflection reduction unit of the ink cartridges.

FIG. 11A is an explanatory diagram illustrating the principle when the ink in the ink cartridge is detected using the prism.

FIG. 11B is an explanatory diagram illustrating the principle when it is detected using the prism that the remaining amount of the ink in the ink cartridge falls below a predetermined value.

FIG. 12 is an explanatory diagram illustrating the reflection light on an incident surface.

FIG. 13 is a graph illustrating an example of output voltage of the detection unit at positions in the main scanning direction when one ink cartridge is passed over the detection unit.

FIG. 14 is a block diagram of the units that perform control of the printing device.

FIG. 15 is a flowchart of processing to detect that the remaining amount of the ink in the ink cartridges falls below a predetermined value.

FIG. 16 is a flowchart illustrating the processing in step S2 of FIG. 15 in detail.

FIG. 17 is a side view illustrating a second type ink cartridge in another embodiment.

FIG. 18 is a side view illustrating a second type ink cartridge in another embodiment.

FIG. 19 is a side view illustrating a second type ink cartridge in another embodiment.

FIG. 20 is a side view illustrating a second type ink cartridge in another embodiment.

FIG. 21 is a side view illustrating a second type ink cartridge in another embodiment.

FIG. 22 is a side view illustrating a second type ink cartridge in another embodiment.

FIG. 23 is a side view illustrating a second type ink cartridge in another embodiment.

### DESCRIPTION OF EXEMPLARY EMBODIMENTS

### A. First Embodiment

### A1. Basic Configuration of Printer

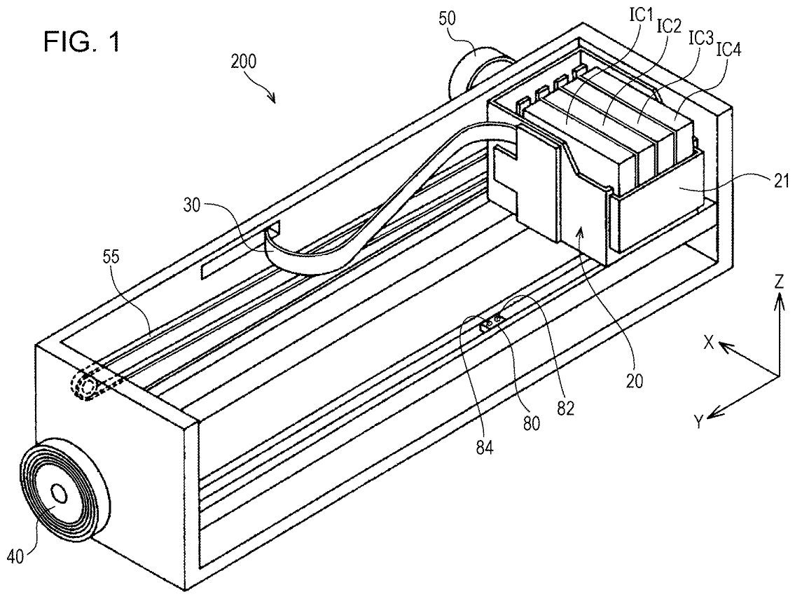

FIG. 1 is a perspective view illustrating the substantial part of a printing device 200 in this embodiment. The printing device 200 is an example of the “liquid consumption device” of the present disclosure. In FIG. 1, the X-axis, the Y-axis, and the Z-axis orthogonal to each other are illustrated. In the printing device 200 disposed on a horizontal plane, the Z-axis negative direction is the vertical downward direction. The horizontal plane is a plane parallel to X-axis direction and Y-axis direction.

The printing device 200 includes a carriage 20, a cable 30, a paper feed motor 40, a paper feed roller 45, a carriage motor 50, a carriage drive belt 55, a detection unit 80, and a control unit 100. It is to be noted that in FIG. 1, the paper feed roller 45 and the control unit 100 are not illustrated.

The carriage 20 is driven by the carriage motor 50 via the carriage drive belt 55, and reciprocates in the Y-axis direction. The carriage 20 is coupled to the control unit 100 via the cable 30. The carriage 20 includes a holder 21, and a print head which is not illustrated in FIG. 1. The holder 21 is an example of the “mounting unit” of the present disclosure.

The holder 21 removably houses ink cartridges IC1 to IC4. The holder 21 includes four liquid supply needles, multiple device-side terminals, four first openings AP1, four second openings AP2, and four light shielding unit SB which are not illustrated in FIG. 1. First openings AP1, second openings AP2, and light shielding units SB will be described later.

The four liquid supply needles are respectively inserted in the ink cartridges IC1 to IC4, and ink is distributed from the ink cartridges IC1 to IC4 to the print head. Ink of one color is stored in each of the ink cartridges IC1 to IC4.

The movement direction when the ink cartridges IC1 to IC4 are mounted to or detached from the holder 21 is Z-axis direction. The movement direction when the ink cartridges IC1 to IC4 are mounted to the holder 21 is the Z-axis negative direction of the Z-axis direction. The movement direction when the ink cartridges IC1 to IC4 are detached from the holder 21 is the Z-axis positive direction of the Z-axis direction.

In a state where the ink cartridges IC are mounted to the printing device 200, the multiple device-side terminals provided in the holder 21 are in contact with multiple substrate terminals respectively included in the ink cartridges IC1 to IC4. Consequently, circuit substrates of the ink cartridges IC1 to IC4 are electrically coupled to the control unit 100 of the printing device 200.

The print head is provided in the surface of the carriage 20, on the Z-axis negative direction side. The ink supplied from the ink cartridges IC1 to IC4 is discharged from the print head to a recording medium. The discharge of ink from the print head is controlled by the control unit 100.

The paper feed motor 40 rotates the paper feed roller 45 which is not illustrated in FIG. 1, and transports a recording medium in the X-axis negative direction. The carriage motor 50 drives the carriage drive belt 55, and moves the carriage 20 bi-directionally along the Y-axis direction. Printing is performed in the printing device 200 by the control unit 100 controlling the discharge and paper feed, and movement of the carriage 20.

In the present description, the direction in which the carriage 20 is moved, that is, the Y-axis direction is also referred to as the “main scanning direction”. The direction in which a recording medium is transported, that is, the X-axis direction is also referred to as the “sub-scanning direction”.

The detection unit 80 outputs a signal for detecting that the ink in the ink cartridges IC1 to IC4 has decreased to a predetermined amount. The detection unit 80 includes a light emitting unit 82 and a light receiving unit 84.

The light emitting unit 82 emits light to the prisms provided in the ink cartridges IC1 to IC4. More specifically, the light emitting unit 82 is configured to emit light to the portions where the prisms are disposed in the ink cartridges IC when the carriage 20 is moved. The prisms of the ink cartridges IC will be described later. The light emitting unit 82 is a light emission diode (LED).

The light receiving unit 84 receives the reflection light from the prisms, and converts the reflection light into an electrical signal. More specifically, the light receiving unit 84 is configured to receive light from the portions where the prisms are disposed in the ink cartridges IC when the carriage 20 is moved. The light receiving unit 84 is comprised of a photo transistor.

The detection unit 80 outputs a signal according to light received by the light receiving unit. The greater the amount of light received by the light receiving unit 84, the more intense signal is outputted by the detection unit 80. Specifically, in a state where the light receiving unit 84 receives no reflection light from any prism, the detection unit 80 outputs a signal with the largest voltage value. The greater the intensity of reflection light received by the light receiving unit 84, the lower voltage signal is outputted by the detection unit 80. It is to be noted that when the reflection light received by the light receiving unit 84 is more intense than a predetermined value, the detection unit 80 outputs a signal with the lowest voltage value.

### A2. Configuration of Ink Cartridge

The ink cartridges IC include a first type ink cartridge ICp, and a second type ink cartridge ICa. The first type ink cartridge ICp is an ink cartridge provided with a prism. The second type ink cartridge ICa is an ink cartridge not provided with a prism, but provided with a reflection reduction unit that reduces reflection of the light received. It is to be noted that the second type ink cartridge ICa has a less amount of ink to be stored than the first type ink cartridge ICp.

The first type ink cartridge ICp and the second type ink cartridge ICa are prepared for each ink color. The first type ink cartridge ICp and the second type ink cartridge ICa are replaceably mounted to the holder 21 for each ink color. Hereinafter, first, the first type ink cartridge ICp will be described, and subsequently, the second type ink cartridge ICa will be described.

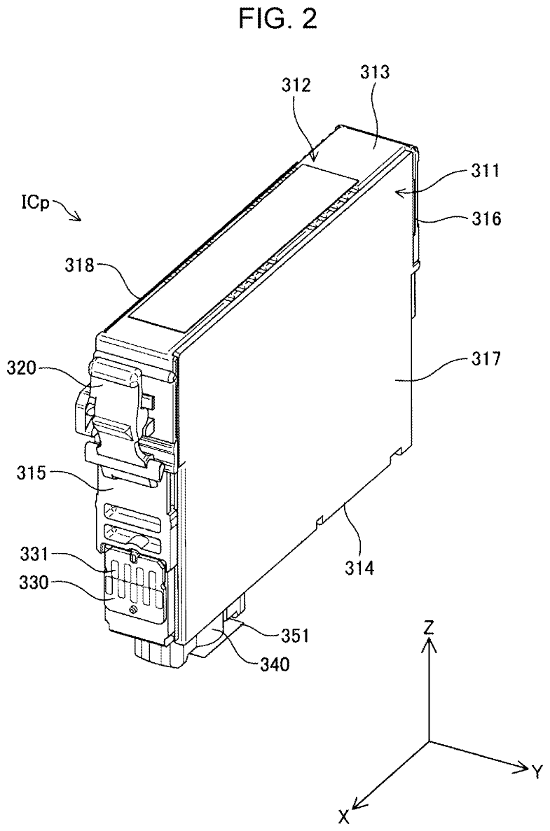

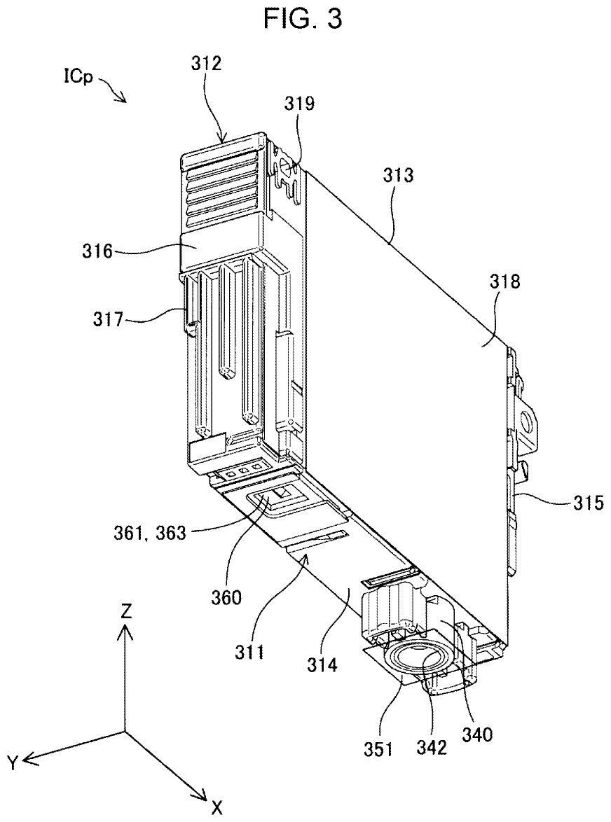

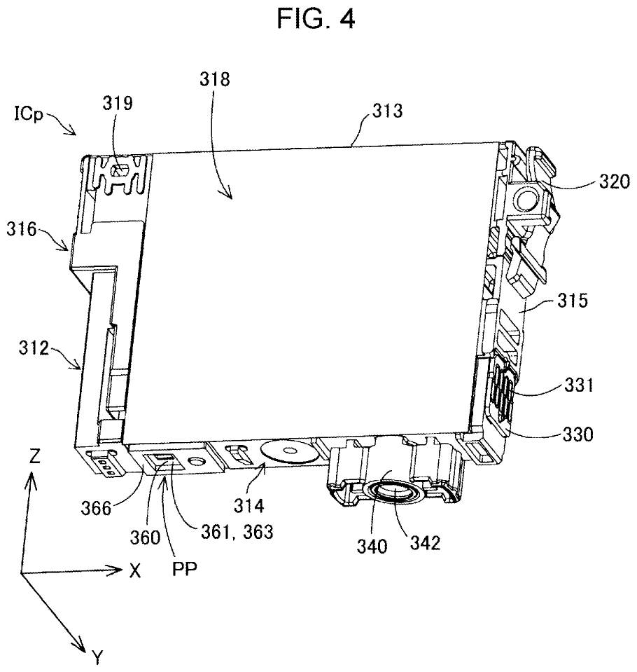

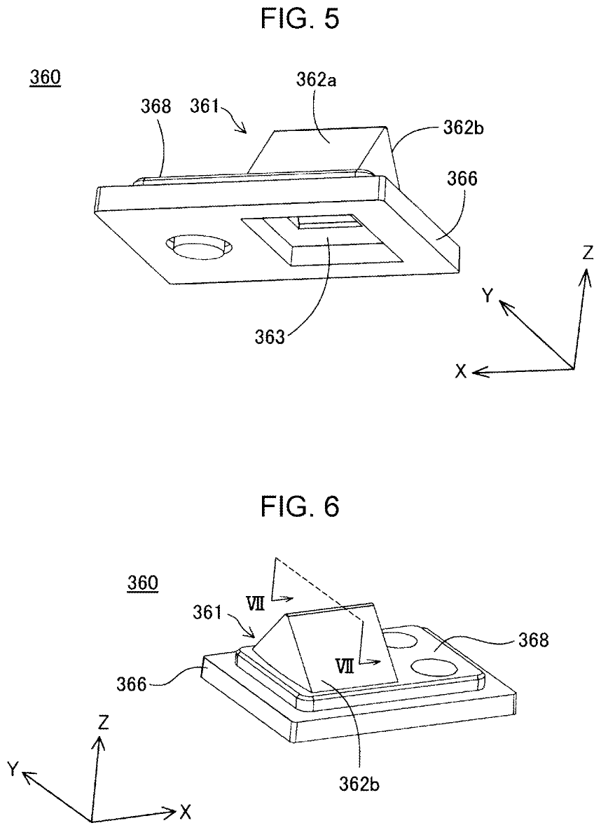

FIG. 2 is an external appearance perspective view of the ink cartridge ICp illustrating a front face 315, a top face 313, and a right face 317 of the first type ink cartridge ICp provided with a prism 361. FIG. 3 is an external appearance perspective view of the ink cartridge ICp illustrating a rear face 316, a bottom face 314, and a left face 318 of the ink cartridge ICp. FIG. 4 is an external appearance perspective view of the ink cartridge ICp illustrating the left face 318, the bottom face 314, and the front face 315 of the ink cartridge ICp. The X-axis, the Y-axis, and the Z-axis illustrated in FIGS. 2 to 4 correspond to the X-axis, the Y-axis, and the Z-axis illustrated in FIG. 1. The same goes with the X-axis, the Y-axis, and the Z-axis illustrated in FIGS. 5 to 23.

As illustrated in FIGS. 2 to 4, the external appearance shape of the ink cartridge ICp is a substantially rectangular parallelepiped. The outer surface of the ink cartridge ICp, that is, the outer shell includes six faces. The six faces are the bottom face 314, the top face 313, the front face 315, the rear face 316, the right face 317, and the left face 318. The six faces 313 to 318 are outer shell members that form the outer shell of the ink cartridge ICp. The faces 313 to 318 each have a planar shape. In the present description, the “planar shape” is used when the entire face is completely planar as well as when part of the face has depressions or projections. The outer shape of each of the faces 313 to 318 as viewed in a direction perpendicular to the face is a substantially rectangle. The outer surface of the ink cartridge ICp includes a film (see FIGS. 3 and 4) that forms part of the left face 318, a container body 312, and a cover member 311 (see FIG. 3). It is to be noted that the cover member 311 is not illustrated in FIG. 4 to facilitate understanding of the technique.

In a state where the ink cartridges IC are mounted to the printing device 200 disposed on a horizontal plane, the bottom face 314 (see FIGS. 3 and 4) is a concept including the wall that forms the bottom wall of the ink cartridge ICp. The bottom face 314 is also referred to as the “bottom face wall section 314”. In the present description, the state where the ink cartridges IC are mounted to the printing device 200 disposed on a horizontal plane is referred to as the “mounted state”.

The top face 313 (see FIG. 2) is a concept including the wall that forms the upper wall of the ink cartridge ICp in the mounted state. The top face 313 is also referred to as the “top face wall section 313”. The front face 315 (see FIGS. 2 and 4) is a concept including the wall that forms the front wall of the ink cartridge ICp in the attached state. The front face 315 is also referred to as the “front face wall section (front face wall) 315”. The rear face 316 (see FIG. 3) is a concept including the wall that forms the rear wall in the mounted state. The rear face 316 is also referred to as the “rear face wall section 316”. The right face 317 (see FIG. 2) is a concept including the wall that forms the right wall in the mounted state. The right face 317 is also referred to as the “right face wall section 317”. The left face 318 (see FIGS. 3 and 4) is a concept including the wall that forms the left wall in the mounted state. The left face 318 is also referred to as the “left face wall section (left face wall) 318”.

In the present description, the “wall section” and the “wall” do not need to be formed by a single wall, and may be formed by multiple members. For instance, the bottom face wall section 314 is a wall positioned on the Z-axis negative direction side of the internal space of the ink cartridge ICp in the mounted state. The bottom face 314 (see FIGS. 3 and 4) is formed by the cover member 311, the container body 312, and a first member unit 360.

The bottom face 314 and the top face 313 are opposed to each other. The front face 315 and the rear face 316 are opposed to each other. The right face 317 and the left face 318 are opposed to each other. The bottom face 314 and the top face 313 are opposed to each other in the Z-axis direction, and are provided on the Z-axis negative direction side and the Z-axis positive direction side, respectively. The front face 315 and the rear face 316 are opposed to each other in the X-axis direction, and are provided on the X-axis positive direction side and the Z-axis negative direction side, respectively. The right face 317 and the left face 318 are opposed to each other in the Y-axis direction, and are provided on the Y-axis positive direction side and the Y-axis negative direction side, respectively.

In the present description, the bottom face 314 is also referred to as a “first face 314”. The rear face 316 is also referred to as a “second face 316”. The front face 315 is also referred to as a “third face 315”. The top face 313 is also referred to as a “fourth face 313”. The right face 317 is also referred to as a “fifth face 317”. The left face 318 is also referred to as a “sixth face 318”.

In the present description, the length of each ink cartridge IC in the X-axis direction is referred to as the “length” of the ink cartridge IC. The length of each ink cartridge IC in the Y-axis direction is referred to as the “width” of the ink cartridge IC. The length of each ink cartridge IC in the Z-axis direction is referred to as the “height” of the ink cartridge IC. Between the length, the width, and the height of the ink cartridge ICp, the length is the largest, and the width is the smallest. It is to be noted that the dimensional relationship between the length, the width, and the height of the ink cartridge ICp may be changed in any way. For instance, the height may be the largest, and the width may be the smallest. Alternatively, the height, the length, and the width may be equal.

A liquid supply unit 340 is disposed on the bottom face 314 projecting therefrom (see FIGS. 3 and 4). The liquid supply unit 340 has a substantially cylindrical shape. A supply port 342 for distributing the ink inside the ink cartridge ICp to the external side is formed in the end face of the liquid supply unit 340. The liquid supply needles provided in the holder 21 of the printing device 200 are inserted into the supply port 342. The ink cartridge ICp is coupled to the holder 21 by inserting the liquid supply needles into the supply port 342. In the ink cartridge ICp before being mounted to the printing device 200, the supply port 342 is closed by a film 351 (see FIGS. 2 and 3). The film 351 is configured to be pierced by the liquid supply needles. The film 351 is not illustrated in FIG. 4 to facilitate understanding of the technique.

On the bottom face 314, the first member unit 360 is provided at a position closer to the rear face 316 than the front face 315 (see FIGS. 3 and 4). On the bottom face 314, the first member unit 360 is provided closer to the rear face 316 than the position at which the liquid supply unit 340 is provided.

The first member unit 360 is utilized for detection of the remaining amount of the liquid in the ink cartridge ICp using the detection unit 80 of the printing device 200. The first member unit 360 is transparent. The first member unit 360 is composed of polypropylene. The first member unit 360 is disposed so that a liquid storage chamber in the ink cartridge ICp may be visually recognized from the outside of the ink cartridge ICp. It is to be noted that the first member unit 360 may be semi-transparent.

The front face 315 intersects with the bottom face 314 (see FIG. 4). The front face 315 intersects with the top face 313 (see FIG. 2). On the front face 315, a circuit substrate 330 is provided at a position closer to the bottom face 314 than the top face 313 (see FIGS. 2 and 4). Multiple substrate terminals 331 are formed on the surface of the circuit substrate 330. In the mounted state, each of the multiple substrate terminals 331 is in contact with corresponding terminals among multiple device-side terminals provided in the holder 21 of the printing device 200. Consequently, the circuit substrate 330 is electrically coupled to the control unit 100 of the printing device 200. Also, a rewritable semiconductor memory 352 is provided in the back face of the circuit substrate 330. Information on the ink cartridge ICp, such as the color, the amount of consumption or the remaining amount of the ink stored in the ink cartridge ICp, is recorded in the semiconductor memory 352. The semiconductor memory 352 is positioned on the back face of the circuit substrate 330, thus is not illustrated in FIGS. 2 and 4.

On the front face 315, a lever 320 is provided at a position closer to the top face 313 than the circuit substrate 330 (see FIGS. 2 and 4). The lever 320 is elastically deformed, and utilized for attachment and detachment of the ink cartridge ICp to and from the printing device 200.

An air opening port 319 is formed in the left face 318 (see FIGS. 3 and 4). The air opening port 319 is an opening for introducing air into the inside of the ink cartridge ICp. After ink is stored in the ink cartridge ICp, a film which seals the air opening port 319 is applied to the ink cartridge ICp before use. When the ink cartridge ICp is used, a user removes the film, and attaches the ink cartridge ICp to the holder 21. FIGS. 3 and 4 illustrate a state in which the film is removed to facilitate understanding of the technique.

The X-axis, the Y-axis, and the Z-axis correspond to the directions as follows, in which the faces 313 to 318 of the rectangular parallelepiped of the ink cartridge ICp are opposed to each other (see FIGS. 2 to 4). The direction in which the bottom face 314 and the top face 313 are opposed to each other is the Z-axis direction. The direction from the bottom face 314 toward the top face 313 is the Z-axis negative direction of the Z-axis direction. The direction from the top face 313 toward the bottom face 314 is the Z-axis positive direction of the Z-axis direction. The direction in which the front face 315 and the rear face 316 are opposed to each other is the X-axis direction. The direction from the rear face 316 toward the front face 315 is the X-axis positive direction of the X-axis direction. The direction from the front face 315 toward the rear face 316 is the X-axis negative direction of the X-axis direction. The direction in which the right face 317 and the left face 318 are opposed to each other is the Y-axis direction. The direction from the left face 318 toward the right face 317 is the Y-axis positive direction of the Y-axis direction. The direction from the right face 317 toward the left face 318 is the Y-axis negative direction of the Y-axis direction.

The X-axis, the Y-axis, and the Z-axis correspond to the structure of the ink cartridge ICp as follows (see FIGS. 2 to 4). The direction in which the liquid supply unit 340 extends is the Z-axis direction. The direction from upstream to downstream in the direction of flow of liquid is the Z-axis negative direction of the Z-axis direction. The direction from downstream to upstream in the direction of flow of liquid is the Z-axis positive direction of the Z-axis direction. The length direction, the width direction, and the height direction of the ink cartridge ICp are the X-axis direction, the Y-axis direction, and the Z-axis direction, respectively.

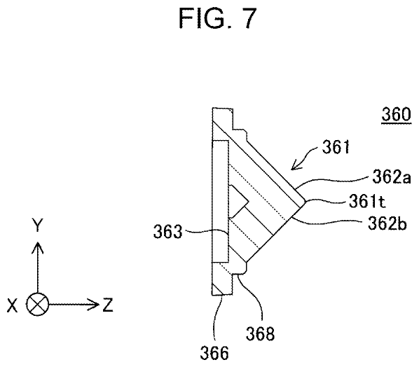

FIG. 5 is an external appearance perspective view, as seen from the bottom face 314, of a first member unit 360 disposed in the bottom face 314 of the ink cartridge ICp. FIG. 6 is an external appearance perspective view of the first member unit 360 as seen from the top face 313 of the ink cartridge ICp. FIG. 7 is a VII-VII cross-sectional view of FIG. 6.

The first member unit 360 includes a prism 361, a mounting section 366, and a base section 368. The prism 361 is a triangular prism having a triangular prism shape. The prism 361 is a right angle prism. In the mounted state, the prism 361 has a first surface 362a and a second surface 362b which are opposed and inclined with respect to a horizontal plane by the same size angle. In this embodiment, the angle of inclination of the first surface 362a and the second surface 362b to a horizontal plane is 45 degrees. The first surface 362a and the second surface 362b are inclined with respect to the Z-axis and to the Y-axis, and parallel to the X-axis (see FIG. 7).

The prism 361 has a ridge line 361t where an apex angle is formed by intersecting with the first surface 362a and the second surface 362b. It is to be noted that the prism may have a configuration in which the first surface 362a and the second surface 362b are coupled via another surface. When the first surface 362a and the second surface 362b do not actually intersect, the ridge line 361t is a line formed by intersection of a virtual plane including the first surface 362a and a virtual plane including the second surface 362b.

The first member unit 360 is disposed on the bottom face 314 so that the first surface 362a and the second surface 362b are positioned in the liquid storage chamber (see FIGS. 3 and 4). When ink is sufficiently stored in the liquid storage chamber, the first surface 362a and the second surface 362b are in contact with the ink in the liquid storage chamber.

The mounting section 366 forms part of the bottom face 314 (see FIG. 4). The base section 368 is disposed on the mounting section 366 (see FIGS. 5 and 6). The prism 361 is disposed on the base section 368 (see FIGS. 5 and 6). Of the base section 368, the surface on which the prism 361 is disposed is exposed into the liquid storage chamber. Meanwhile, the bottom face 363 of the prism 361 is exposed in the bottom face 314 of the ink cartridge ICp (see FIGS. 3 and 4).

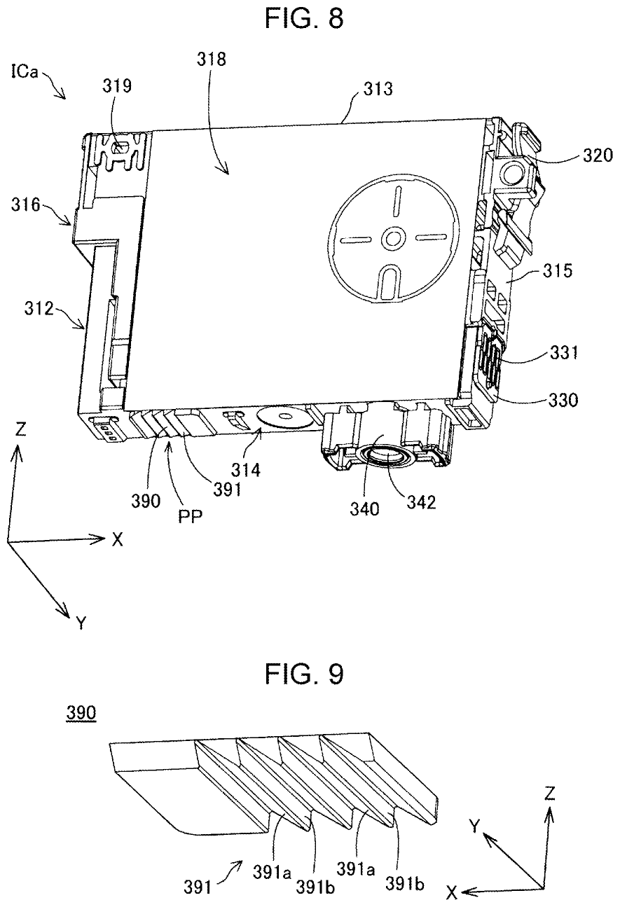

FIG. 8 is an external appearance perspective view of a second type ink cartridge ICa provided with a reflection reduction unit 391. FIG. 8 illustrates the left face 318, the bottom face 314, and the front face 315 of the ink cartridge ICa. The ink cartridge ICa includes a second member unit 390 instead of the first member unit 360 (see FIG. 4) including the prism 361. The second member unit 390 includes the reflection reduction unit 391 that reduces reflection of light received. The ink cartridge ICa has the same configuration as that of the ink cartridge ICp except that the reflection reduction unit 391 is provided instead of the prism 361.

On the bottom face 314 of the ink cartridge ICa, the second member unit 390 is provided at a position closer to the rear face 316 than the front face 315. On the bottom face 314, the second member unit 390 is provided closer to the rear face 316 than the position at which the liquid supply unit 340 is provided. The second member unit 390 is not utilized for detection of the remaining amount of the liquid in the ink cartridge ICa using the detection unit 80 (see FIG. 1) of the printing device 200. The second member unit 390 is not transparent. In this embodiment, the second member unit 390 has a black color.

The second member unit 390 includes the reflection reduction unit 391 on the Z-axis negative direction side. In a state where the second member unit 390 is incorporated in the ink cartridge ICa, the reflection reduction unit 391 is positioned at a site PP where the prism 361 is disposed in the ink cartridge ICp (see FIGS. 4 and 8). The site PP where the prism 361 and the reflection reduction unit 391 are provided in the ink cartridges ICp, ICa is at a common location, which is predetermined.

FIG. 9 is an external appearance perspective view, as seen from the bottom face 314, of a second member unit 390 disposed in the bottom face 314 of the ink cartridge ICa. The reflection reduction unit 391 has four first surfaces 391a and four second surfaces 391b. The first surfaces 391a and the second surfaces 391b are alternately arranged along the X-axis direction.

The first surfaces 391a are each a slanted surface inclined with respect to the X-axis and to the Z-axis, and the second surfaces 391b are each a vertical surface perpendicular to the X-axis, and parallel to the Z-axis. The first surfaces 391a and the second surfaces 391b are each parallel to the Y-axis. In the mounted state, the first surfaces 391a are each surface which faces the X-axis positive direction side and the Z-axis negative direction side, and is parallel to the Y-axis. The first surfaces 391a are each surface inclined with respect to the X-axis and to the Z-axis. The first surfaces 391a each intersect with the X-axis and the Z-axis at an angle which is not a right angle. In the mounted state, the second surfaces 391b are each surface which faces the X-axis negative direction side, and is parallel to the Y-axis and the Z-axis. The second surfaces 391b are each surface perpendicular to the X-axis. The second surfaces 391b are each surface parallel to YZ plane formed by the Y-axis and the Z-axis.

The light emitted from the light emitting unit 82 to the reflection reduction unit 391 is reflected by a first surface 391a which is a slanted surface, thereby being directed in a direction different from the Z-axis negative direction, that is, the direction in which the light receiving unit 84 is positioned. The light emitted from the light emitting unit 82 to the reflection reduction unit 391 is repeatedly reflected by the multiple first surfaces 391a and second surfaces 391b, thereby being diffused or absorbed. Thus, the light which travels in the Z-axis negative direction decreases. In this manner, the reflection reduction unit 391 may reduce the light which travels to the light receiving unit 84.

### A3. Structure of Bottom Face of Holder

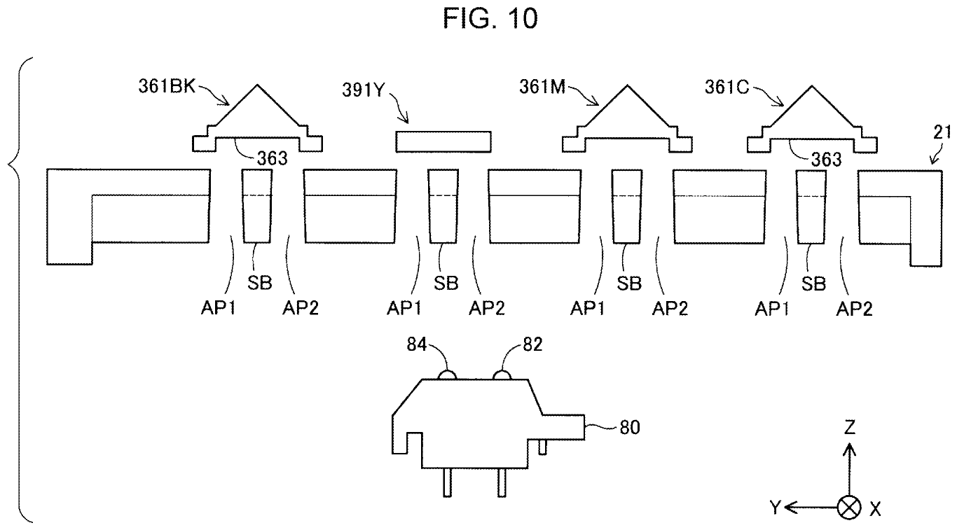

FIG. 10 is an explanatory diagram illustrating a relationship between the holder 21 and the prism 361 or the reflection reduction unit 391 of the ink cartridges IC1 to IC4. The bottom wall of the holder 21 is provided with four sets of a first opening AP1, a second opening AP2, and a light shielding unit SB. The sets of the first opening AP1, the second opening AP2, and the light shielding unit SB are each provided at a position opposed to a site where a prism 361 or a reflection reduction unit 391 of the ink cartridges IC1 to IC4 is provided. In FIG. 10, only the prisms 361 or the reflection reduction units 391 of the ink cartridges IC1 to IC4 are illustrated to facilitate understanding of the technique.

In the example of FIG. 10, the cartridge which stores yellow ink is the second type ink cartridge ICa provided with the reflection reduction unit 391, and the cartridges which store ink of other colors are the first type ink cartridges ICp each provided with the prism 361. In FIG. 10, the prism 361 of the ink cartridge ICp which stores black ink is denoted by a prism 361BK. The reflection reduction unit 391 of the ink cartridge ICa which stores yellow ink is denoted by a reflection reduction unit 391Y. The prism 361 of the ink cartridge ICp which stores magenta ink is denoted by a prism 361M. The prism 361 of the ink cartridge ICp which stores cyan ink is denoted by a prism 361C.

### A4. Principle of Processing of Detecting Remaining Amount of Ink

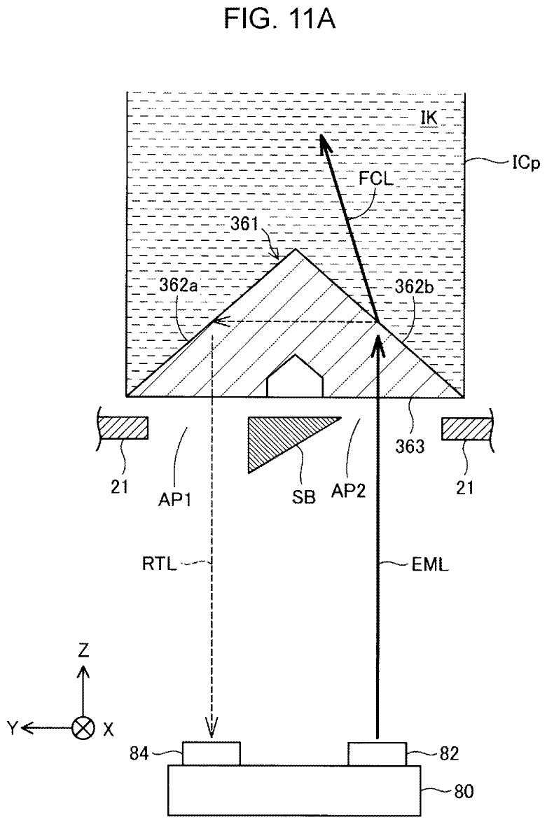

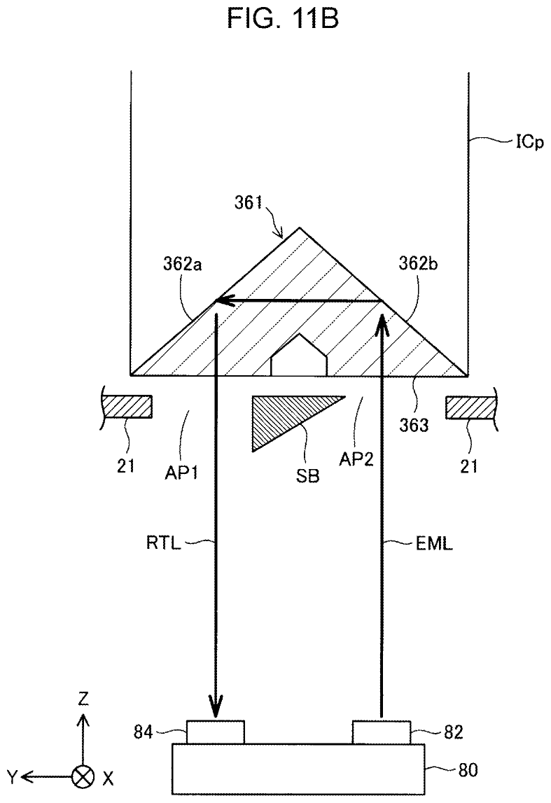

FIG. 11A is an explanatory diagram illustrating the principle when the ink in the ink cartridge ICp is detected using the prism 361. FIG. 11A illustrates a state where the prism 361 of an ink cartridge ICp is at a position facing the detection unit 80. More specifically, for each ink cartridge ICp, the face 363 of the prism 361 on the Z-axis negative direction side is at a position facing the light receiving unit 84 and the light emitting unit 82 via a first opening AP1 and a second opening AP2 in the main scanning direction Y. The face 363 of the prism 361 on the Z-axis negative direction side is also referred to as an “incident surface 363”.

When the liquid storage chamber of an ink cartridge ICp is filled with ink IK, light EML, which is emitted from the light emitting unit 82 toward the Z-axis positive direction and incident to the prism 361 through the second opening AP2, enters into the ink IK through the second surface 362b. In FIG. 11A, the light incident to the ink IK is denoted by light FCL.

In this embodiment, each prism 361 is composed of polypropylene. When it is assumed that the refractive index of ink is 1.5 which is substantially equal to the refractive index of water, the critical angle for total reflection on the first surface 362a and the second surface 362b is approximately 64 degrees. In contrast, the incident angle of light to the second surface 362b and the first surface 362a is 45 degrees. Thus, the incident light EML is not totally reflected by the second surface 362b and the first surface 362a, and enters into the ink IK. Consequently, the mount of light RTL reflected by the second surface 362b and the first surface 362a is significantly small. Thus, the light receiving unit 84 hardly receives the reflection light RTL. Consequently, the detection unit 80 outputs an significantly weak signal. Specifically, the detection unit 80 outputs a signal with a voltage value close to a maximum value. It is noted that the amount of light RTL reflected by the second surface 362b and the first surface 362a slightly varies with the type of the ink in each ink cartridge ICp.

FIG. 11B is an explanatory diagram illustrating the principle when it is detected using the prism 361 that the remaining amount of the ink in the ink cartridge ICp falls below a predetermined value. The ink IK in the ink cartridge ICp is consumed by printing. Consequently, a portion the first surface 362a and the second surface 362b of the prism 361 is in contact with air, the portion being irradiated with the light from the light emitting unit 82. FIG. 11B illustrates a state where an ink cartridge ICp is at the same position as in FIG. 11A in such a state.

When the refractive index of air is assumed to be 1, the critical angle for total reflection on the first surface 362a and the second surface 362b is approximately 43 degrees. In contrast, the incident angle of light to the second surface 362b and the first surface 362a is 45 degrees. Thus, the incident light EML is totally reflected by the first surface 362a and the second surface 362b. The reflection light RTL is emitted to the outside of the prism 361 through the incident surface 363. The light receiving unit 84 receives the reflection light RTL which passed through the second opening AP2. Consequently, the detection unit 80 outputs a signal which is more intense than in FIG. 11A. Specifically, the detection unit 80 outputs a signal which is lower than a voltage value in FIG. 11A.

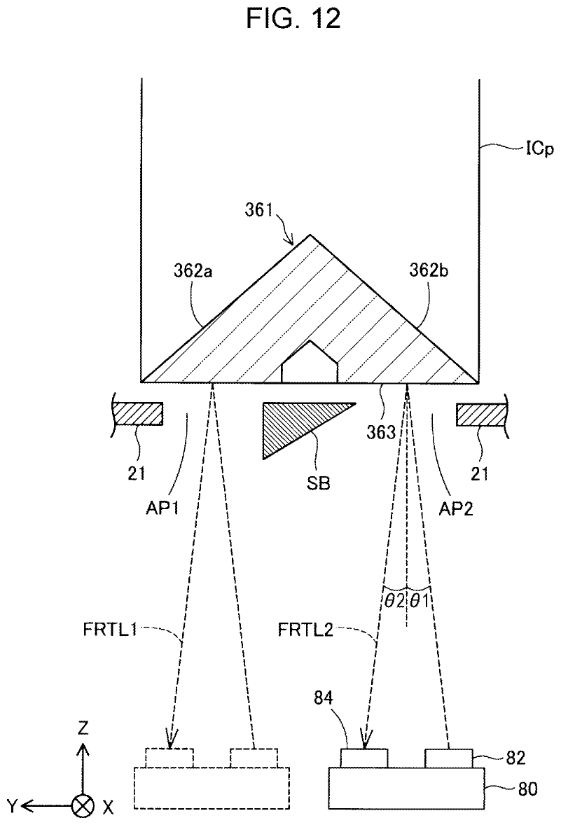

FIG. 12 is an explanatory diagram illustrating the reflection light on an incident surface 363. The reflection light of light emitted from the light emitting unit 82 includes the reflection light reflected on the incident surface 363 without being emitted into the prism 361 other than the reflection light RTL passed through the prism 361 and reflected, described with reference to FIGS. 11A and 11B.

Part of light, which is emitted from the light emitting unit 82 and reaches the incident surface 363 of the prism through the second opening AP2, is reflected by the incident surface 363, and received by the light receiving unit 84 as reflection light FRTL2. More specifically, light having an optical path, in which an incidence angle θ1 from the light emitting unit 82 to the incident surface 363 and an incidence angle θ2 from the incident surface 363 to the light receiving unit 84 are equal, is received by the light receiving unit 84. Similarly, part of light, which is emitted from the light emitting unit 82 and reaches the incident surface 363 of the prism through the first opening AP1, is also reflected by the incident surface 363, and received by the light receiving unit 84 as reflection light FRTL1. Consequently, in the processing of detecting the remaining amount of ink, the detection unit 80 also outputs a signal originating from the reflection light FRTL2 and a signal originating from the reflection light FRTL1.

When the liquid storage chamber of an ink cartridge ICp is filled with ink IK, signals originating from the significantly weak reflection light RTL illustrated in FIG. 11A, and the reflection light FRTL1, FRTL2 illustrated in FIG. 12 are outputted from the detection unit 80. On the other hand, when the remaining amount of the ink in the liquid storage chamber of an ink cartridge ICp falls below a predetermined value, signals originating from the intense reflection light RTL illustrated in FIG. 11B, and the reflection light FRTL1, FRTL2 illustrated in FIG. 12 are outputted from the detection unit 80.

The ink cartridge ICa is not provided with a prism 361 (see FIGS. 8 and 9). Thus, the reflection light RTL reflected by the first surface 362a and the second surface 362b of the prism 361 as illustrated in FIGS. 11A and 11B does not exist in the ink cartridge ICa. However, similarly to the reflection light FRTL1, FRTL2 described with reference to FIG. 12, the light reflected by the surface of the reflection reduction unit 391 exists only slightly. However, in the reflection reduction unit 391, the first surface 391a and the second surface 391b inclined with respect to the X-axis and to the Z-axis are alternately provided along the X-axis direction. Also, the reflection reduction unit 391 has a black color. Thus, emission light having an intense component in the Z-axis positive direction from the light emitting unit 82 is hardly reflected by the reflection reduction unit 391 in the Z-axis negative direction, that is, the direction in which the light receiving unit 84 is positioned. In other words, the reflection of light to the light receiving unit 84 is reduced by the reflection reduction unit 391, the light being emitted to the site PP.

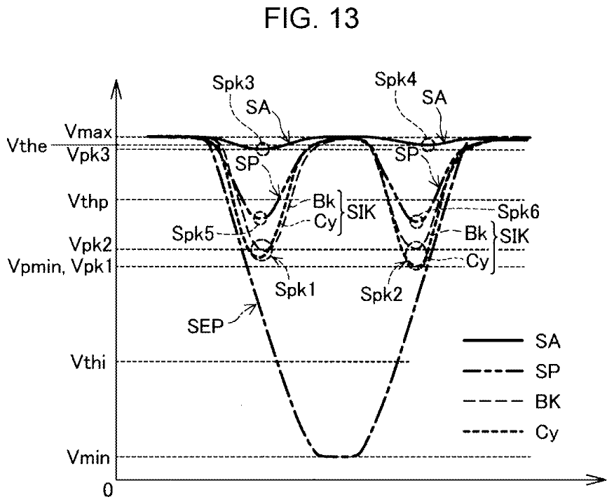

FIG. 13 is a graph illustrating an example of output voltage of the detection unit 80 at positions in the main scanning direction of one ink cartridge ICa or ICp when the ink cartridge ICa or ICp is passed over the detection unit 80. The horizontal axis of FIG. 13 indicates the relative position between the reflection reduction unit 391 of the ink cartridge ICa or the prism 361 of the ink cartridge ICp, and the detection unit 80 in the Y-axis direction (see FIG. 1). The vertical axis of FIG. 13 indicates the voltage of a detected signal outputted from the detection unit 80.

As described above, as the amount of light received by the light receiving unit 84 becomes closer to zero, the output voltage of the detection unit 80 becomes closer to an upper limit Vmax. As the amount of light received by the light receiving unit 84 becomes greater, the output voltage of the detection unit 80 becomes closer to a lower limit Vmin. However, when the amount of light received by the light receiving unit 84 exceeds a predetermined value, the output voltage becomes the lower limit Vmin.

In FIG. 13, an output voltage SIK is the output voltage when a first type ink cartridge ICp is filled with the ink IK (see FIGS. 11A and 12). When the liquid storage chamber of the ink cartridge ICp is filled with the ink IK, signals originating from the reflection light RTL illustrated in FIG. 11A, and the reflection light FRTL1, FRTL2 illustrated in FIG. 12 are outputted from the detection unit 80. However, the reflection light RTL illustrated in FIG. 11A is significantly weaker than the reflection light FRTL1, FRTL2 illustrated in FIG. 12. Thus, the output voltage when the liquid storage chamber is filled with the ink IK, the reflection light RTL illustrated in FIG. 12 is the dominant. Consequently, the output voltage SIK has two downward peaks Spk1 and Spk2.

The amount of the reflection light RTL slightly varies with the type of the ink in each ink cartridge ICp. Thus, the output voltage SIK also varies with the type of the ink. Of the output voltage SIK, the output voltage for the ink cartridge ICp of black ink is denoted by Bk. Of the output voltage SIK, the output voltage for the ink cartridge ICp of cyan ink is denoted by Cy. Of the output voltage SIK, the output voltage of the ink cartridge ICp of black ink is higher in the weakest detected signal, that is, the minimum value of output voltage. Of the output voltage SIK, the output voltage of the ink cartridge ICp of cyan ink is lower in the weakest detected signal, that is, the minimum value of output voltage. FIG. 13 illustrates these two typical output voltages Bk, Cy out of the output voltage SIK when the first type ink cartridge ICp is filled with the ink IK.

In FIG. 13, an output voltage SEP is the output voltage when the remaining amount of the ink in the ink cartridge ICp falls below a predetermined value (see FIGS. 11B and 12). When the remaining amount of the ink in the ink cartridge ICp falls below a predetermined value, signals originating from the reflection light RTL illustrated in FIG. 11B, and the reflection light FRTL1, FRTL2 illustrated in FIG. 12 are outputted from the detection unit 80. However, the reflection light RTL illustrated in FIG. 11B is significantly stronger than the reflection light FRTL1, FRTL2 illustrated in FIG. 12. Thus, in the output voltage when the remaining amount of the ink in the ink cartridge ICp falls below a predetermined value, the reflection light RTL illustrated in FIG. 11B is the dominant. Consequently, the output voltage SEP has one downward peak. It is noted that in the example of FIG. 13, a minimum value of the output voltage SEP has reached the lower limit Vmin.

In FIG. 13, an output voltage SA is the output voltage of the ink cartridge ICa. In the ink cartridge ICa, reflection to the light receiving unit is reduced by the reflection reduction unit 391. Consequently, a signal originating from significantly weak reflection light (see FIG. 12) reflected by the surface of the reflection reduction unit 391 is outputted from the detection unit 80. Thus, the output voltage SA of the ink cartridge ICa also has two downward peaks. However, the signal then is significantly lower than the peaks Spk1, Spk2 of the signal when the ink cartridge ICp is filled with the ink IK.

In FIG. 13, an output voltage SP is the output voltage of an ink cartridge of a comparative example. In the ink cartridge of a comparative example, the bottom face 314 is not provided with neither a reflection reduction unit nor a prism. In the ink cartridge of a comparative example, a section corresponding to the prism 361 of the ink cartridge ICp and the reflection reduction unit 391 of the ink cartridge ICa is a planar section. The planar section is comprised of the same surface as the bottom face 314. The planar section is formed integrally with the bottom face 314 by the same material as used for the bottom face 314. The planar section is continuous to the bottom face 314. The ink cartridge of a comparative example has the same configuration as that of the first type ink cartridge ICp and the second type ink cartridge ICa except that a section corresponds to the prism 361 or the reflection reduction unit 391. Also in the ink cartridge of a comparative example, a signal originating from reflection light (see FIG. 12) reflected by the planar section is outputted from the detection unit 80. Thus, the output voltage SP of the ink cartridge of a comparative example also has two downward peaks. The signal then is slightly lower than the peaks Spk1, Spk2 of the output voltage SIK of the first type ink cartridge ICp, but is quite higher than the peaks Spk3, Spk4 of the output voltage SA of the second type ink cartridge ICa. In other words, the minimum value of the voltage of the output voltage SP is slightly higher than the minimum value of the output voltage SIK of the ink cartridge ICp, and is quite lower than the minimum value of the output voltage SA of the ink cartridge ICa. The profile of the output voltage SP of the ink cartridge of a comparative example is quite similar to the profile of the output voltage SIK when the first type ink cartridge ICp is filled with the ink.

A threshold Vthi illustrated in FIG. 13 is a threshold for determining based on the output voltage of the detection unit 80 whether or not the remaining amount of the ink in the ink cartridge ICp falls below a predetermined value in the first type ink cartridge ICp provided with the prism 361. The threshold Vthi is set to a value higher than the lower limit Vmin of the output voltage SEP when the remaining amount of the ink in the ink cartridge ICp falls below a predetermined value, and lower than a minimum value Vpk1 of the output voltage SIK when the ink cartridge ICp is filled with the ink IK. In the processing of detecting the remaining amount of ink, the control unit 100 compares the minimum value of the output voltage of the detection unit 80 with the threshold Vthi, thereby determining whether or not the remaining amount of the ink in the ink cartridge ICp falls below a predetermined value.

A threshold Vthp illustrated in FIG. 13 is a threshold for determining based on the output voltage of the detection unit 80 whether the ink cartridge IC is a first type ink cartridge ICp provided with the prism 361 or a second type ink cartridge ICa provided with the reflection reduction unit 391. The threshold Vthp is set to a value which is higher than the greatest value Vpk2 among the downward peak values of the output voltage SIK when the ink cartridge ICp is filled with the ink IK, and is lower than a minimum value Vpk3 of the output voltage SA of the ink cartridge ICa. In the processing of detecting the remaining amount of ink, the control unit 100 compares the minimum value of the output voltage of the detection unit 80 with the threshold Vthp, thereby determining whether or not the ink cartridge IC is a first type ink cartridge ICp provided with the prism 361 or a second type ink cartridge ICa provided with the reflection reduction unit 391.

In this embodiment, a second type ink cartridge ICa not provided with the prism 361 includes the reflection reduction unit 391 at the site PP where the prism 361 is provided in a first type ink cartridge ICp. In contrast, the ink cartridge of a comparative example does not include the reflection reduction unit 391 at the site PP which is a planar section. As seen from the comparison between the profile of the output voltage SA of the second type ink cartridge ICa in FIG. 13, and the output voltage SP of the ink cartridge of a comparative example, the second type ink cartridge ICa includes the reflection reduction unit 391 at the site PP, thus the amount of light travelling from the site PP to the light receiving unit 84 is significantly small. Consequently, the profile of the output voltage SP of the ink cartridge of a comparative example is quite similar to the profile of the output voltage SIK when the first type ink cartridge ICp is filled with the ink, whereas the profile of the output voltage SA of the second type ink cartridge ICa is quite different from the profile of the output voltage SIK when the first type ink cartridge ICp is filled with the ink. Similarly to the voltage values of peaks Spk1 and Spk2 of the first type ink cartridge ICp filled with the ink, the voltage values of peaks Spk5 and Spk6 of the output voltage SP of the ink cartridge of a comparative example are lower than the threshold Vthp. Thus, the control unit 100 is unable to distinguish between the ink cartridge of a comparative example and the first type ink cartridge ICp filled with the ink. When an ink cartridge of a comparative example is mounted to the holder (see FIG. 1), the control unit 100 determines that the cartridge is the first type ink cartridge ICp filled with the ink. In contrast, the voltage values of peaks Spk3 and Spk4 of the output voltage SA of the second ink cartridge ICa are each greater than the threshold Vthp. Thus, the control unit 100 is able to determine based on the output voltage of the detection unit 80 whether the ink cartridge mounted to the holder 21 (see FIG. 1) is the first type ink cartridge ICp or the second type ink cartridge ICa.

This indicates that as an ink cartridge not provided with the prism 361, an ink cartridge provided with a planar section by simply removing the prism 361 from the bottom face 314 of the first type ink cartridge ICp like the ink cartridge of a comparative example is not adopted, but an ink cartridge provided with the reflection reduction unit 391 instead of the prism 361 like the second type ink cartridge ICa of this embodiment is adopted, and thus it is not necessary to provide a structure for exclusive use for determining the type of an ink cartridge in the printing device 200.

In addition, when an ink cartridge of a comparative example instead of the first type ink cartridge ICp is mounted to the holder 21 (see FIG. 1), the control unit 100 determines that the cartridge of a comparative example is the first type ink cartridge ICp filled with the ink regardless of the remaining amount of the ink stored inside. In other words, the control unit 100 is unable to determine that the remaining amount of the ink in the ink cartridge of a comparative example falls below a predetermined value. Thus, when the cartridge of a comparative example is adopted, the head without ink is driven, and failure may occur in the head. In contrast, when the first type ink cartridge ICp provided with the reflection reduction unit 391 instead of the prism 361 is adopted like the second type ink cartridge ICa of this embodiment, the control unit 100 is able to determine whether the ink cartridge mounted to the holder 21 is the first type ink cartridge ICp or the second type ink cartridge ICa. When the ink cartridge is determined to be the second type ink cartridge ICa, the remaining amount of ink may be determined or managed by a method different from the method used for the first type ink cartridge ICp. Thus, it is possible to prevent the head without the ink from being driven. The detailed processing steps related to determination of the type of ink cartridge, and management of the remaining amount of ink will be described in detail in the following.

### A5. Processing of Detecting Remaining Amount of Ink

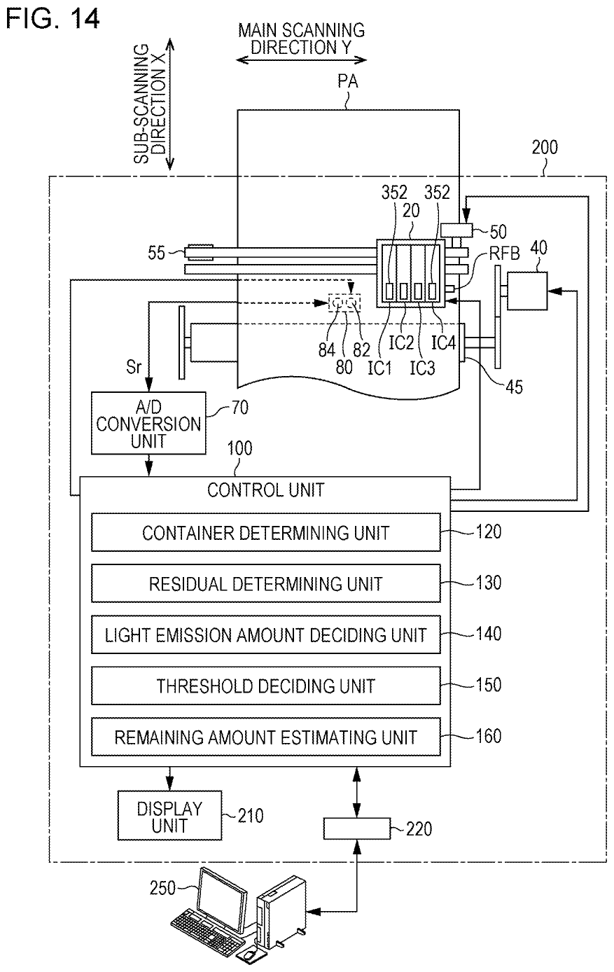

FIG. 14 is a block diagram of the units that perform control of the printing device 200. The printing device 200 includes an A/D conversion unit 70, a control unit 100, a display unit 210, and an interface unit 220 as the configuration to implement the control of the printing device 200.

The control unit 100 receives image data from a personal computer 250 via the interface unit 220, controls the units of the printing device 200, and prints an image on a recording medium PA based on the image data. The control unit 100 includes a central processing unit (CPU), a random access memory (RAM), and a read only memory (ROM). The control unit 100 loads a control program stored in the ROM into the RAM, executes the control program in the CPU, thereby implementing various functions. In FIG. 14, a container determining unit 120, a residual determining unit 130, a light emission amount deciding unit 140, a threshold deciding unit 150, and a remaining amount estimating unit 160 are illustrated as the functional units of the control unit 100.

The A/D conversion unit 70 converts an analog voltage to a digital signal. More specifically, an output signal Sr of the detection unit 80 is A/D-converted by the A/D conversion unit 70, and is inputted to the control unit 100 as a digital signal. The output voltage of the detection unit 80 are obtained as multiple output voltages, that is, as sampling voltages at predetermined position intervals by the control unit 100.

The container determining unit 120 determines the type of liquid container mounted to the holder 21. More specifically, the container determining unit 120 determines whether the ink cartridges IC1 to IC4 mounted to the holder 21 are a first type ink cartridge ICp provided with the prism 361 or a second type ink cartridge ICa provided with the reflection reduction unit 391. The determination is made based on the signal Sr outputted by the detection unit 80, more specifically, the sampling voltages obtained by the A/D conversion unit 70. The method of determining the type of ink cartridge IC is as described in A4 (see Vthp of FIG. 13).

The residual determining unit 130 determines a residual state of the liquid in the ink cartridge IC. More specifically, the residual determining unit 130 determines whether or not the remaining amount of ink in the ink cartridges IC1 to IC4 falls below a predetermined value, based on the sampling voltages from the A/D conversion unit 70. The method of the determination is as described in A4 (see Vthi of FIG. 13). For each ink cartridge which is determined to have the remaining amount of ink less than a predetermined value, the residual determining unit 130 outputs instructions for displaying alarm to prompt for ink replacement on the display unit 210 of the printing device 200 and the display unit of the personal computer 250, for instance. A user informed of alarm to prompt for ink replacement replaces an ink cartridge.

Even after the determination by the residual determining unit 130 that the remaining amount of ink falls below a predetermined value, printing using the ink cartridge IC mounted then to the holder 21 may be allowed. On the other hand, when it is determined by the residual determining unit 130 that the remaining amount of ink falls below a predetermined value, subsequently, printing may not be performed until the ink cartridge is replaced.

The light emission amount deciding unit 140 performs processing of deciding the light emission amount of the light emitting unit 82 based on the output voltage from the detection unit 80. The light emission amount deciding unit 140 writes the decided light emission amount into the semiconductor memory 352 of the ink cartridges IC1 to IC4. The control unit 100 controls the light emission amount of the light emitting unit 82 based on the decided light emission amount. The light emission amount deciding processing by the light emission amount deciding unit 140 is performed before processing of detecting the amount of ink is performed by the residual determining unit 130.

The remaining amount estimating unit 160 estimates the remaining amount of ink in each ink cartridge IC. Specifically, the remaining amount estimating unit 160 performs the processing in the following. The remaining amount estimating unit 160 counts the number of ink droplets ejected from the print head, and calculates the amount of ink consumed by multiplying the number of ink droplets counted, and the mass per ink droplet. The remaining amount estimating unit 160 determines an estimated value of the remaining amount of ink by subtracting the calculated amount of ink consumed from the initial fill amount of the ink in each ink cartridge IC. The remaining amount estimating unit 160 records the estimated value of the remaining amount of ink in the RAM of the control unit 100, and the semiconductor memory 352 included in a corresponding ink cartridge IC.

The remaining amount estimating unit 160 obtains the remaining amount of ink from the semiconductor memory 352 of each ink cartridge IC, for instance, at the time of starting the printing device 200, and stores the remaining amount of ink in the RAM of the control unit 100. The remaining amount estimating unit 160 calculates the amount of consumption of ink used for execution of printing and cleaning of the print head while the power supply of the printing device 200 is turned on, and subtracts the amount of consumption of ink from the remaining amount of ink to update the value in the RAM. When instructions to turn off the power supply of the printing device 200 are inputted or an ink cartridge is replaced, or each time a predetermined amount of ink is consumed, the remaining amount estimating unit 160 writes an estimated remaining amount updated in the semiconductor memory 352 of each ink cartridge. The remaining amount estimating unit 160 may estimate various amounts of ink, such as the amount of consumption of ink, instead of the remaining amount of ink.

The threshold deciding unit 150 decides thresholds Vthi, Vthp of the output voltage of the detection unit 80 (see FIG. 13). The threshold Vthi is a threshold for determining based on the output voltage of the detection unit 80 whether or not the remaining amount of the ink in the ink cartridge ICp falls below a predetermined value. The threshold Vthp is a threshold for determining based on the output voltage of the detection unit 80 whether the ink cartridge IC is the first type ink cartridge ICp or the second type ink cartridge ICa. The processing of deciding the thresholds Vthi, Vthp of the output voltage of the detection unit 80 is performed before processing of detecting the amount of ink.

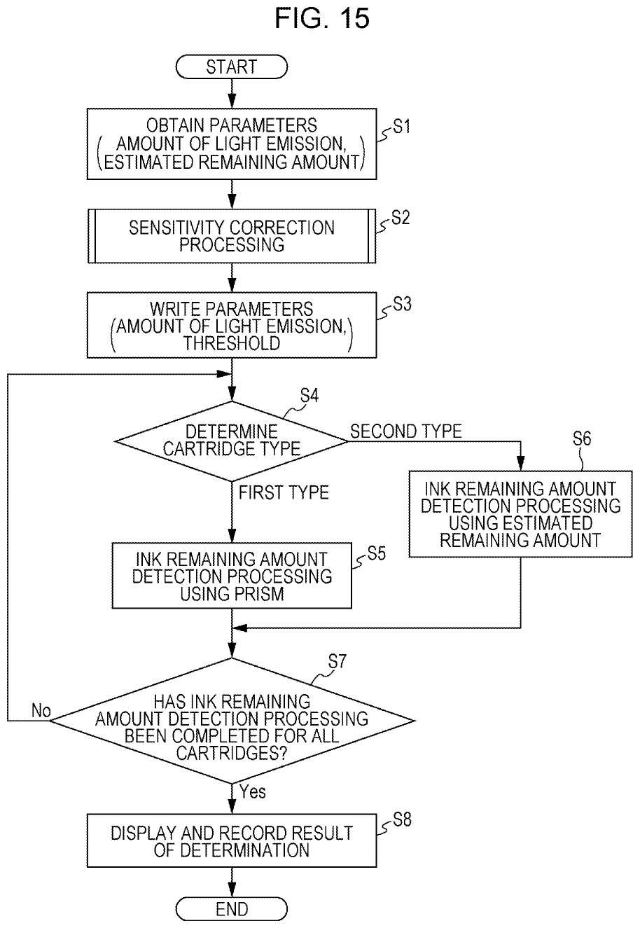

FIG. 15 is a flowchart of processing to detect that the remaining amount of the ink in the ink cartridges IC1 to IC4 falls below a predetermined value. The processing of detecting that the remaining amount of the ink in the ink cartridges IC1 to IC4 falls below a predetermined value is also referred to as “ink remaining amount detection processing”. The ink remaining amount detection processing is performed at various timings, for instance, when the printing device 200 is started, when one of the ink cartridges IC1 to IC4 is replaced, when an estimated value of the remaining amount of ink determined by the remaining amount estimating unit 160 falls below a predetermined amount.

In step S1, the control unit 100 obtains the parameters used in the processing in or after step S2. Specifically, the control unit 100 obtains the light emission amount of the light emitting unit 82 determined in previous sensitivity correction processing (see S2) from the semiconductor memory 352 of the ink cartridges IC1 to IC4, and obtains estimated remaining amounts of ink of the ink cartridges IC1 to IC4 from the RAM of the control unit 100. At the time of power supply ON of the printing device 200, the estimated remaining amount of ink is read from the semiconductor memory 352 of the ink cartridges IC1 to IC4 to the RAM of the control unit 100 by the remaining amount estimating unit 160, and subsequently, is updated one by one by the above-described processing.

In step S2, the control unit 100 performs the sensitivity correction processing. In the sensitivity correction processing, processing of deciding a new light emission amount of the light emitting unit 82 is performed by the light emission amount deciding unit 140, and processing of deciding a threshold for the ink remaining amount detection processing is performed by the threshold deciding unit 150. The new light emission amount is a light emission amount used by the processing in steps S4 and S5.

In step S3, the control unit 100 writes the new light emission amount and threshold determined by the sensitivity correction processing of step S2 in the semiconductor memory 352 of the ink cartridges IC1 to IC4.

In step S4, the control unit 100 determines the type of one of the ink cartridges IC1 to IC4. Specifically, the control unit 100 causes the carriage 20 to reciprocate in the main scanning direction, the light emitting unit 82 of the detection unit 80 to emit light to the ink cartridges IC, and the light receiving unit 84 to receive reflection light (see FIG. 10). The control unit 100 determines the type of ink cartridge IC based on the output voltage of the detection unit 80. The details of specific processing are as described in A4 (see Vthp of FIG. 13). The determination of the type of ink cartridge IC is made by the container determining unit 120 as a functional unit of the control unit 100 (see FIG. 14). When the ink cartridge IC is the first type ink cartridge ICp provided with the prism 361, the processing proceeds to step S5. When the ink cartridge IC is the second type ink cartridge ICa not provided with the prism 361, the processing proceeds to step S6.

In step S5, the residual determining unit 130 determines whether or not the remaining amount of the ink in the ink cartridge ICp of the type determined in step S4 falls below a predetermined value utilizing the prism 361. The principle of ink remaining amount detection processing using the prism 361 is as described in A4 (see Vthi of FIG. 13).

In step S6, the residual determining unit 130 determines whether or not the remaining amount of the ink in the ink cartridge ICa of the type determined in step S4 falls below a predetermined value, based on the estimated value of the remaining amount of ink determined by the remaining amount estimating unit 160. The estimated value of the remaining amount of ink determined by the remaining amount estimating unit 160 is recorded in the RAM of the control unit 100 and the semiconductor memory 352 of the ink cartridge ICa. It is to be noted that the second type ink cartridge ICa has a less amount of ink to be stored than the first type ink cartridge ICp. Thus, even when determination is made using the estimated value of the remaining amount of ink determined by the remaining amount estimating unit 160 without measuring the actual state of the ink in the ink cartridge ICa, sufficient determination accuracy is assured. In other words, in the processing of S6, information based on the reflection light from the prism 361, more specifically, the output signal of the detection unit 80 is not utilized.

By performing such processing, it is possible to determine a residual state of the ink of the first type ink cartridge ICp provided with the prism 361 by utilizing the prism 361. For the second type ink cartridge ICa provided with the reflection reduction unit 391 instead of the prism 361, it is possible to determine and manage a residual state of the ink appropriately by utilizing information recorded in the ink cartridge ICa or the printing device 200.

In step S7, the control unit 100 determines whether or not the ink remaining amount detection processing in step S5 or step S6 has been performed for all the ink cartridges IC1 to IC4. When there is an ink cartridge IC for which the ink remaining amount detection processing has not been performed, the control unit 100 performs the processing in and after step S4 for the next ink cartridge IC as the processing target. When the ink remaining amount detection processing has been performed for all the ink cartridges IC1 to IC4, the processing proceeds to step S8.

In step S8, for the ink cartridges IC1 to IC4, the control unit 100 displays a result of determination as to whether or not the remaining amount of ink falls below a predetermined value on the display unit 210 and the display unit of the personal computer 250 (see FIG. 14). Also, the control unit 100 writes the result of determination in the semiconductor memory 352 of the ink cartridges IC1 to IC4. Subsequently, the processing of FIG. 15 is completed.

It is to be noted that steps S1 to S3 of the processing of FIG. 15, which are the processing for setting parameters for ink remaining amount detection, may be performed when the power supply of the printing device 200 is turned on or when an ink cartridge is replaced. Steps S4 to S8 of the processing of FIG. 15, which are actual ink remaining amount detection processing may be performed at predetermined timing during a print job or printing in addition to when the power supply of the printing device 200 is turned on or when an ink cartridge is replaced.

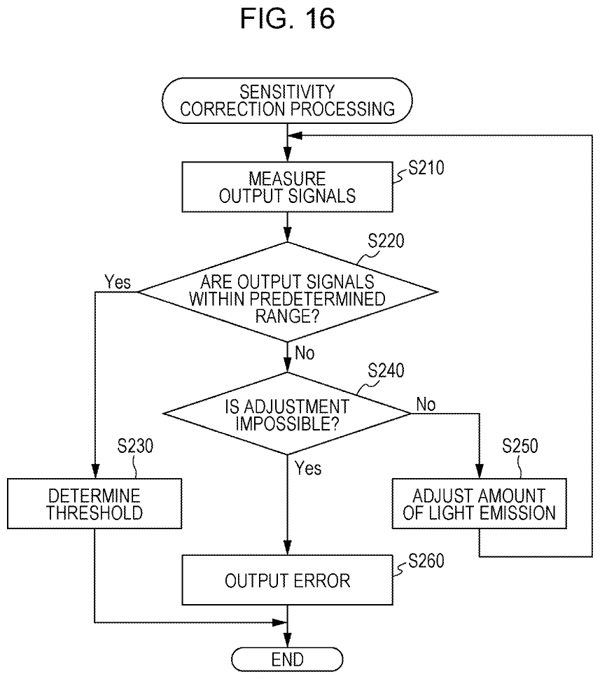

FIG. 16 is a flowchart illustrating the processing in step S2 of FIG. 15 in detail. In step S210, the light emission amount deciding unit 140 as a functional unit of the control unit 100 causes the carriage 20 to reciprocate in the main scanning direction, the light emitting unit 82 of the detection unit 80 to emit light to the ink cartridges IC, and obtains the output signal of the detection unit 80 for the ink cartridges IC1 to IC4 (see FIG. 10). The light emission amount of the light emitting unit 82 when step S210 is first performed is a maximum value within a predetermined adjustable range of light emission amount.

In step S220, the light emission amount deciding unit 140 refers to the semiconductor memory 352 of the ink cartridges IC1 to IC4, and identifies an ink cartridge IC having a remaining amount of ink not falling below a predetermined value (see S5, S6, and S8 of FIG. 15), of the ink cartridges IC1 to IC4. The light emission amount deciding unit 140 identifies the minimum value of each output voltage of an ink cartridge IC having a remaining amount of ink not falling below a predetermined value. Each output voltage of an ink cartridge IC having a remaining amount of ink not falling below a predetermined value is the output voltage SIK or SA in FIG. 13. The minimum value of each output voltage of an ink cartridge IC having a remaining amount of ink not falling below a predetermined value is Vpk1 of the output voltage Cy, Vpk2 of the output voltage Bk, and Vpk3 of the output voltage SA in FIG. 13.

The light emission amount deciding unit 140 determines the minimum value Vpmin (Vpk1 of FIG. 13) of the locally minimum values of the output voltage of an ink cartridge IC having a remaining amount of ink not falling below a predetermined value. The light emission amount deciding unit 140 determines whether or not the minimum value Vpmin of the locally minimum values of the output voltage falls within a predetermined range. The predetermined range may be a partial range including the average value of the lower limit Vmin and the upper limit Vmax of the output voltage, for instance. When the minimum value Vpmin of the locally minimum values of the output voltage is within a predetermined range, the processing proceeds to step S230. When the minimum value Vpmin of the locally minimum values of the output voltage is out of a predetermined range, the processing proceeds to step S240.

In step S230, the threshold deciding unit 150 as a functional unit of the control unit 100 decides the threshold Vthp based on the minimum value Vpmin of the locally minimum values of the output voltage, and the upper limit Vmax of the output voltage (see FIG. 13). The threshold Vthp is a threshold for determining based on the output voltage of the detection unit 80 whether the ink cartridge IC is a first type ink cartridge ICp provided with the prism 361 or a second type ink cartridge ICa provided with the reflection reduction unit 391. The threshold Vthp is set a value higher than Vpmin and lower than Vmax. The threshold Vthp may be the average value of Vpmin and Vmax, for instance.

The threshold deciding unit 150 decides the threshold Vthi based on the minimum value Vpmin (Vpk1 of FIG. 13) of the locally minimum values of the output voltage, and the lower limit Vmin of the output voltage. The threshold Vthi is a threshold for determining based on the output voltage of the detection unit 80 whether or not the remaining amount of the ink in the first type ink cartridge ICp provided with the prism 361 falls below a predetermined value. The threshold Vthi is set a value lower than Vpmin and higher than Vmin. The threshold Vthi may be the average value of Vpmin and Vmin, for instance.

After the processing in step S230, the processing of FIG. 16 is completed.

In contrast, in step S240, the light emission amount deciding unit 140 determines whether or not it is impossible to set the minimum value Vpmin of the locally minimum values of the output voltage within a predetermined range by adjustment of the light emission amount. Specifically, the light emission amount deciding unit 140 determines whether or not one of the following cases is satisfied. When one of the following cases is satisfied, it is impossible to set the minimum value Vpmin of the locally minimum values of the output voltage within a predetermined range by adjustment of the light emission amount.

(i) When the minimum value Vpmin of the locally minimum values of the output voltage exceeds a predetermined range, and the light emission amount then of the light emitting unit 82 is an upper limit of a predetermined adjustable range. It is to be noted that when the minimum value Vpmin of the locally minimum values of the output voltage exceeds a predetermined range indicates that the amount of light of the reflection light from the ink cartridge IC falls below a desirable range. (ii) When the minimum value Vpmin of the locally minimum values of the output voltage falls below a predetermined range, and the light emission amount then of the light emitting unit 82 is a lower limit of a predetermined adjustable range. It is to be noted that when the minimum value Vpmin of the locally minimum values of the output voltage falls below a predetermined range indicates that the amount of light of the reflection light from the ink cartridge ICp exceeds a desirable range.

When it is impossible to set the minimum value Vpmin of the locally minimum values of the output voltage within a predetermined range by adjustment of the light emission amount, the processing proceeds to step S260. When it is possible to set the minimum value Vpmin of the locally minimum values of the output voltage within a predetermined range by adjustment of the light emission amount, the processing proceeds to step S250.

As described above, when step S210 is first performed, the light emission amount of the light emitting unit 82 is a maximum value of a predetermined adjustable range of light emission amount. Thus, when step S240 is first performed, in many cases, the minimum value Vpmin of the locally minimum values of the output voltage falls below a predetermined range. In other words, the amount of light of the reflection light from the ink cartridge ICp exceeds a desirable range. Consequently, in step S240, it is determined that adjustment is possible and the processing proceeds to step S250.

In step S250, the light emission amount deciding unit 140 adjusts the light emission amount of the light emitting unit 82. More specifically, (i) when the minimum value Vpmin of the locally minimum values of the output voltage exceeds a predetermined range, in other words, when the amount of light of the reflection light falls below a desirable range, the light emission amount deciding unit 140 increases the light emission amount of the light emitting unit 82. (ii) When the minimum value Vpmin of the locally minimum values of the output voltage falls below a predetermined range, in other words, when the amount of light of the reflection light exceeds a desirable range, the light emission amount deciding unit 140 decreases the light emission amount of the light emitting unit 82. The processing returns to step S210.

As described above when step S240 is first performed, in many cases, the minimum value Vpmin of the locally minimum values of the output voltage falls below a predetermined range. In other words, the amount of light of the reflection light from the ink cartridge ICp exceeds a desirable range. Consequently, in step S250, the light emission amount deciding unit 140 decreases the light emission amount of the light emitting unit 82.

In step S210 which is performed for the second time and later, the light emitting unit 82 is emitted with the light emission amount set in step S250. When each unit of the printing device 200 functions normally, the processing in steps S210 to S250 is repeated, thus the light emission amount of the light emitting unit 82 is gradually decreased from the maximum value, and the minimum value Vpmin of the locally minimum values of the output voltage of the ink cartridge IC is set to a value within a predetermined range (see S220).

In step S260, the light emission amount deciding unit 140 records an error in the RAM of the control unit 100, and outputs an error on the display unit 210 of the printing device 200 and the display unit of the personal computer 250. Subsequently, the processing of FIG. 16 is completed.

By performing the processing of FIG. 16, the light emission amount of the light emitting unit 82 is decided so that the waveform of the output voltage SIK when the ink cartridge ICp is filled with ink becomes appropriate and distinguishable from the output voltage SEP when the remaining amount of the ink in the ink cartridge ICp falls below a predetermined value, and the output voltage SA of the ink cartridge ICa (see S220, S250, and FIG. 13).

By performing the processing of FIG. 16, it is possible to set the threshold Vthp for distinguishing between the output voltage SIK and the output voltage SA so that cartridge determination processing in S4 of FIG. 15 is appropriately performed (see FIG. 13). In addition, it is possible to set the threshold Vthi for distinguishing between the output voltage SIK and the output voltage SEP so that the ink remaining amount detection processing in S5 of FIG. 15 is appropriately performed (see S220, S230, and FIG. 13).

### B. Another Embodiment of Second Type Ink Cartridge

In the first embodiment, the second member unit 390 of the ink cartridge ICa has a black color. The first surfaces 391a of the reflection reduction unit 391 of the second member unit 390 are each surface which faces the X-axis positive direction side and the Z-axis negative direction side, and is parallel to the Y-axis (see FIG. 9). The second surfaces 391b are each surface which faces the X-axis negative direction side and the Z-axis positive direction side, and is parallel to the Y-axis. However, the reflection reduction unit 391 may have another configuration. Even when the configuration of the reflection reduction unit is changed to another embodiment as in the following, the same effects as in the first embodiment may be obtained.

### B1. Another Embodiment 1 of Second Type Ink Cartridge

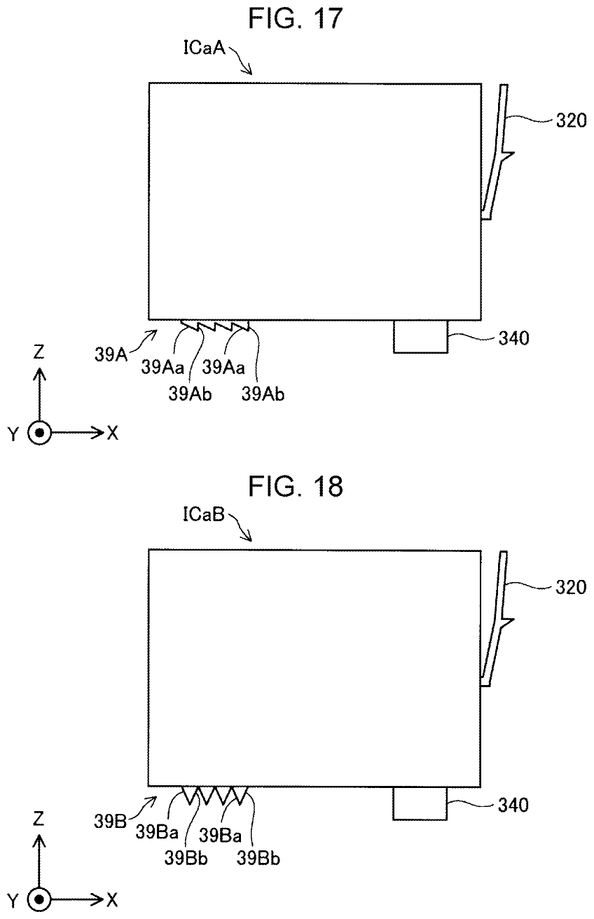

FIG. 17 is a side view illustrating a second type ink cartridge ICaA in another embodiment. In this embodiment, similarly to the reflection reduction unit 391 (see FIGS. 8 and 9) of the second type ink cartridge ICa in the first embodiment, a reflection reduction unit 39A of an ink cartridge ICaA has four first surfaces 39Aa and four second surface 39Ab. The first surfaces 39Aa and the second surfaces 39Ab are alternately arranged in the X-axis direction. The first surfaces 39Aa are each a slanted surface inclined with respect to the X-axis and to the Z-axis, and the second surfaces 39Ab are each a vertical surface perpendicular to the X-axis, and parallel to the Z-axis. The first surfaces 39Aa are each surface which faces the X-axis negative direction side and the Z-axis negativedirection side, and is parallel to the Y-axis. The second surfaces 39Ab are each surface which faces the X-axis positive direction side, and is parallel to the Y-axis and the Z-axis. In the reflection reduction unit 391 (see FIGS. 8 and 9) of the second type ink cartridge ICa in the first embodiment, the first surfaces 391a face the positive direction of the X-axis. In contrast, in the reflection reduction unit 39A of the second type ink cartridge ICaA in this embodiment, the first surfaces 39Aa face the negative direction of the X-axis. In the second type ink cartridge ICaA, the configuration other than the reflection reduction unit 39A is the same as the configuration of the second type ink cartridge ICa described in the first embodiment.

Even when the orientation of the first surfaces 39Aa is changed in this manner, similarly to the first embodiment, light reflected to the light receiving unit 84 may be reduced.

### B2. Another Embodiment 2 of Second Type Ink Cartridge

FIG. 18 is a side view illustrating a second type ink cartridge ICaB in another embodiment. In this embodiment, a reflection reduction unit 39B of an ink cartridge ICaB has four first surfaces 39Ba and four second surfaces 39Bb. In the first embodiment (see FIG. 9), of the faces included in the reflection reduction unit 391, the first surfaces 391a are each a slanted surface inclined with respect to the X-axis and to the Z-axis, and the second surfaces 391b are each a vertical surface perpendicular to the X-axis, and parallel to the Z-axis. In this embodiment, both the first surfaces 39Ba and the second surfaces 39Bb are each a slanted surface inclined with respect to the X-axis and to the Z-axis. In the first embodiment, the reflection reduction unit 391 includes slanted surfaces and vertical surfaces, whereas in this embodiment, the reflection reduction unit 39B includes two types of slanted surfaces having different inclinations. The first surfaces 39Ba and the second surfaces 39Bb are alternately arranged in the X-axis direction. The first surfaces 39Ba are each surface which faces the X-axis negative direction side and the Z-axis negative direction side, and is parallel to the Y-axis. The first surfaces 39Ba are each surface inclined with respect to the X-axis and to the Z-axis. The first surfaces 39Ba each intersect with the X-axis and the Z-axis at an angle which is not a right angle. The second surfaces 39Bb are each surface which faces the X-axis positive direction side and the Z-axis negative direction side, and is parallel to the Y-axis. The second surfaces 39Bb are each surface inclined with respect to the X-axis and to the Z-axis. The second surfaces 39Bb each intersect with the X-axis and the Z-axis at an angle which is not a right angle. The first surface 39Ba and the second surface 39Bb adjacent to each other form symmetrical angles with respect to the YZ plane. In the second type ink cartridge ICaB, the configuration other than the reflection reduction unit 39B is the same as the configuration of the second type ink cartridge ICa described in the first embodiment.

The light emitted from the light emitting unit 82 to the reflection reduction unit 39B is reflected by a first surface 39Ba and a second surface 39Bb which are slanted surfaces, thereby being directed in a direction different from the Z-axis negative direction, that is, the direction in which the light receiving unit 84 is positioned. The light emitted from the light emitting unit 82 to the reflection reduction unit 39B is repeatedly reflected by the multiple first surfaces 39Ba and second surfaces 39Bb, thereby being diffused or absorbed.

Even when the second surfaces 39Bb are changed from vertical surfaces to slanted surfaces in this manner, similarly to the first embodiment, light reflected to the light receiving unit 84 may be reduced.

### B3. Another Embodiment 3 of Second Type Ink Cartridge

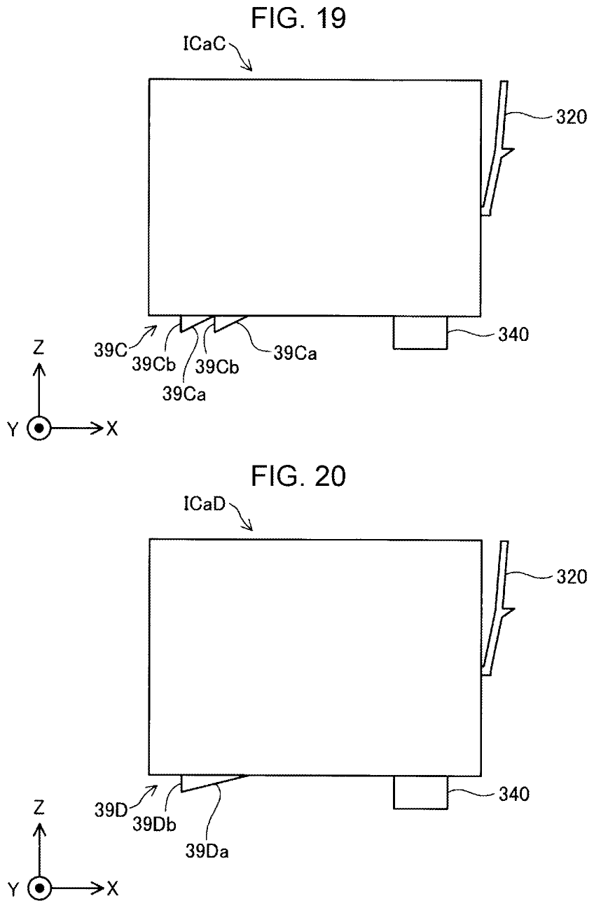

FIG. 19 is a side view illustrating a second type ink cartridge ICaC in another embodiment. In the second type ink cartridge ICa (see FIGS. 8 and 9) in the first embodiment, the reflection reduction unit 391 has four pairs of the first surface 391a and the second surface 391b. In contrast, a reflection reduction unit 39C of the second type ink cartridge ICaC in this embodiment has two pairs of the first surface 39Ca and two pairs of the second surface 39Cb. In other words, in this embodiment, the reflection reduction unit 39C of the second type ink cartridge ICaC has two first surfaces 39Ca and two second surfaces 39Cb. The first surfaces 39Ca and the second surfaces 39Cb are alternately arranged in the X-axis direction. In the second type ink cartridge ICaC, the configuration other than the reflection reduction unit 39C is the same as the configuration of the second type ink cartridge ICa described in the first embodiment.

The first surfaces 39Ca of the reflection reduction unit 39C correspond to the first surfaces 391a of the reflection reduction unit 391. The second surfaces 39Cb of the reflection reduction unit 39C correspond to the second surfaces 391b of the reflection reduction unit 391. Also in this embodiment, the light emitted from the light emitting unit 82 to the reflection reduction unit 39C is directed by a first surface 39Ca which is a slanted surface, in a direction different from the Z-axis negative direction, that is, the direction in which the light receiving unit 84 is positioned. The light emitted from the light emitting unit 82 to the reflection reduction unit 391 is repeatedly reflected by the multiple first surfaces 39Ca and second surfaces 39Cb, thereby being diffused or attenuated. However, the number of the first surfaces 39Ca and second surfaces 39Cb is less than the number in the reflection reduction unit 391 (see FIG. 9) in the first embodiment, and the reflection reduction units 39A and 39B (see FIGS. 17 and 18) in the above-described other embodiments, thus this embodiment may be slightly inferior to these embodiments related to the effects of diffusion and absorption.

In any case, even when the number of slanted surfaces and vertical surfaces included in the reflection reduction unit 39C is changed, the light which travels to the light receiving unit 84 may be reduced. Even in this embodiment, as in other embodiments described previously, it is possible to change the orientation of the first surfaces 39Ca, or to change the second surfaces 39Cb from vertical surfaces to slanted surfaces.

It is to be noted that the number of the slanted surfaces of the reflection reduction unit is not limited to two (see FIG. 19), four (see FIGS. 9 and 18), and eight (see FIG. 19), and may be a different number such as three, five, and one or greater.

### B4. Another Embodiment 4 of Second Type Ink Cartridge

FIG. 20 is a side view illustrating a second type ink cartridge ICaD in another embodiment. In the second type ink cartridge ICa (see FIGS. 8 and 9) in the first embodiment, the reflection reduction unit 391 has four pairs of the first surface 391a and the second surface 391b. In contrast, a reflection reduction unit 39D of the second type ink cartridge ICaD in this embodiment has one pair of the first surface 39Da and the second surface 39Db. In other words, in this embodiment, the reflection reduction unit 39D has one first surface 39Da and one second surface 39Db. In the second type ink cartridge ICaD, the configuration other than the reflection reduction unit 39D is the same as the configuration of the second type ink cartridge ICa described in the first embodiment.

The first surface 39Da of the reflection reduction unit 39D corresponds to the first surface 391a of the reflection reduction unit 391. The second surface 39Db of the reflection reduction unit 39D corresponds to the second surface 391b of the reflection reduction unit 391.

The light emitted from the light emitting unit 82 to the reflection reduction unit 39D is reflected by the first surface 39Da which is a slanted surface, thereby being directed in a direction different from the Z-axis negative direction, that is, the direction in which the light receiving unit 84 is positioned.

In this embodiment, the first surface 39Da of the reflection reduction unit 39D functions as a light guiding unit that guides the light emitted from the light emitting unit 82 to the reflection reduction unit 391 in the Z-axis negative direction, that is, the direction in which the light receiving unit 84 is positioned.

In this manner, the light which travels to the light receiving unit 84 may be also reduced by the reflection reduction unit 39D including the light guiding unit.

Even in this embodiment, as in other embodiments described previously, it is possible to change the orientation of the first surfaces 39Da, or to change the second surfaces 39Db from vertical surfaces to slanted surfaces.

### B5. Another Embodiment 5 of Second Type Ink Cartridge

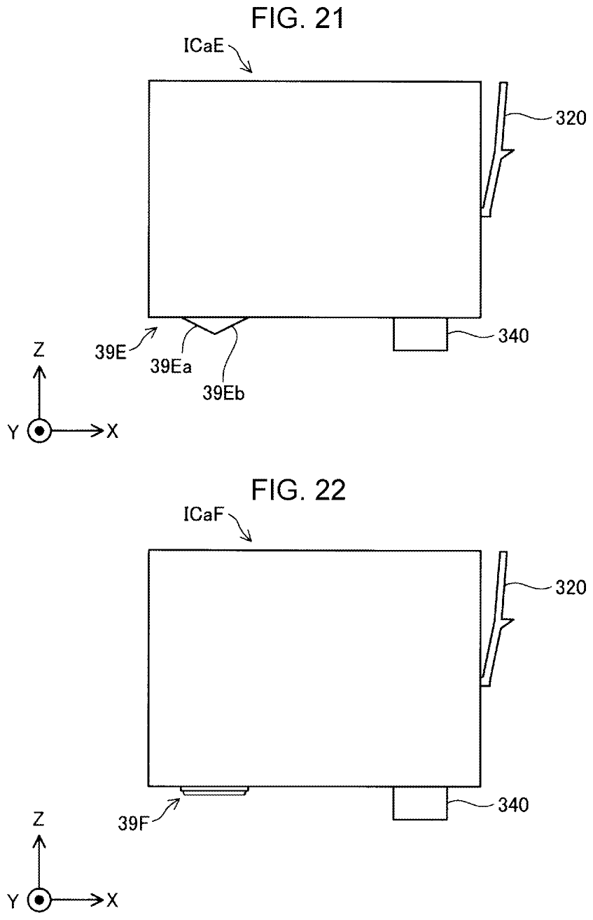

FIG. 21 is a side view illustrating a second type ink cartridge ICaE in another embodiment. This embodiment has a configuration in which in the ink cartridge ICaD illustrated in FIG. 20, the second surfaces 39Cb of the reflection reduction unit 39D are changed from vertical surfaces to slanted surfaces. In the second type ink cartridge ICaE, the configuration other than a reflection reduction unit 39E is the same as the configuration of the ink cartridge ICaD illustrated in FIG. 20.

The first surface 39Ea is a surface which faces the X-axis negative direction side and the Z-axis negative direction side, and is parallel to the Y-axis. The first surface 39Ea is a surface inclined with respect to the X-axis and to the Z-axis. The first surface 39Ea intersects with the X-axis and the Z-axis at an angle which is not a right angle. The second surface 39Eb is a surface which faces the X-axis positive direction side and the Z-axis negative direction side, and is parallel to the Y-axis. The second surface 39Eb is a surface inclined with respect to the X-axis and to the Z-axis. The second surface 39Eb intersects with the X-axis and the Z-axis at an angle which is not a right angle. The first surface 39Ea and the second surface 39Eb form symmetrical angles with respect to the YZ plane.

The light emitted from the light emitting unit 82 to the reflection reduction unit 39E is reflected by the first surface 39Ea and the second surface 39Eb which are slanted surfaces, thereby being directed in a direction different from the Z-axis negative direction, that is, the direction in which the light receiving unit 84 is positioned.

In this embodiment, the first surface 39Ea and the second surface 39Eb of the reflection reduction unit 39E each function as a light guiding unit that guides the light emitted from the light emitting unit 82 to the reflection reduction unit 391 in the Z-axis negative direction, that is, the direction in which the light receiving unit 84 is positioned. In this manner, the light which travels to the light receiving unit 84 may be also reduced by the reflection reduction unit 39E including two light guiding units.

### B6. Another Embodiment 6 of Second Type Ink Cartridge

FIG. 22 is a side view illustrating a second type ink cartridge ICaF in another embodiment. In this embodiment, a reflection reduction unit 39F of an ink cartridge ICaF includes a light diffusion unit having fine depressions and projections on the surface instead of a slanted surface and/or a vertical surface included in the reflection reduction unit in the embodiments described previously. The light emitted from the light emitting unit 82 to the reflection reduction unit 39F is diffused or absorbed by such fine depressions and projections. Thus, the light which travels in the Z-axis direction decreases. In this manner, the reflection reduction unit 39F may reduce the light which travels to the light receiving unit 84.

Various shapes are known as shapes which diffuse the received light. Those various shapes may be adopted as light diffusion units that diffuse light emitted to the reflection reduction unit. The shape of the reflection reduction unit 39F as a light diffusion unit may be provided by casting, physical processing such as sandblasting, or chemical processing using acid or the like.

### B7. Another Embodiment 7 of Second Type Ink Cartridge

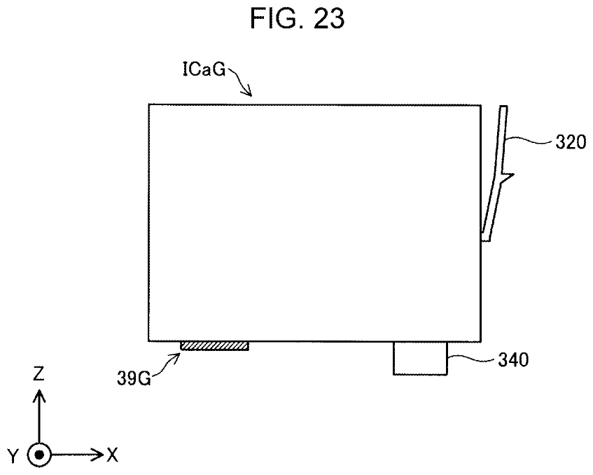

FIG. 23 is a side view illustrating a second type ink cartridge ICaG in another embodiment. In this embodiment, a reflection reduction unit 39G of an ink cartridge ICaG includes a light absorbing unit composed of black porous materials instead of a slanted surface and/or a vertical surface included in the reflection reduction unit in the embodiments described previously. The light emitted from the light emitting unit 82 to the reflection reduction unit 39G is absorbed by the light absorbing unit. Thus, the light which travels in the Z-axis direction decreases. In this manner, the reflection reduction unit 39G may reduce the light which travels to the light receiving unit 84.

Various materials are known as materials which absorb received light. Those various materials may be adopted as light absorbing units. A light absorbing unit may be implemented by coating a material, or by attaching a sheet composed of a material which absorbs received light.

### C. Other Embodiment

### C1. Another Embodiment 1

(1) In the first embodiment, the sensitivity correction processing has been described in which the light emission amount of the light emitting unit 82 is adjusted (see S250 of FIG. 16). However, the processing of step S250 is not limited to a configuration in which the light emission amount of the light emitting unit 82 is adjusted, but may be a configuration in which the output voltage is adjusted by adjusting the sensitivity of the light receiving unit 84. Alternatively, a configuration may be adopted, in which the output voltage is adjusted by adjusting both the light emission amount of the light emitting unit 82 and the sensitivity of the light receiving unit 84.

It is to be noted that the light emission amount (see FIG. 16) in the ink remaining amount detection processing may be decided for each ink cartridge IC, or may be decided as a common light emission amount for the multiple ink cartridges IC mounted in the carriage.

(2) In the first embodiment, the threshold deciding unit 150 decides the threshold Vthi based on the minimum value Vpmin of the locally minimum values of the output voltage, and the lower limit Vmin of the output voltage (see FIGS. 13 and S230 of FIG. 16). However, the threshold Vthi used in the ink remaining amount detection processing (see S5 of FIG. 15) may also be decided by another method. For instance, the threshold Vthi may be defined based on the minimum value Vpmin of the locally minimum values of the output voltage (Vpk1 of FIG. 13), and a minimum value of the output voltage SEP which has not reached a lower limit.

(3) In the first embodiment, the threshold deciding unit 150 decides the threshold Vthp based on the minimum value Vpmin of the locally minimum values of the output voltage, and the upper limit Vmax of the output voltage (see FIGS. 13 and S230 of FIG. 16). However, the threshold Vthp used in the processing of determining the type of cartridge (see S4 of FIG. 15) may also be decided by another method. For instance, the threshold Vthp may be defined based on the maximum value (Vpk2 of FIG. 13) of the locally minimum values (Vpk1, Vpk2 of FIG. 13) of the output voltage SIK of the ink cartridge ICp, and the minimum value of the output voltage SA of the ink cartridge ICa. The threshold Vthp may be defined based on the maximum value (Vpk2 of FIG. 13) of the locally minimum values of the output voltage, and the upper limit Vmax of the output voltage.

(4) In the first embodiment, the type of ink cartridge IC is determined by comparing the output voltage with the threshold Vthp (see S4 of FIG. 15). However, the type of ink cartridge IC may be determined by comparing the waveform of the output voltage with a reference waveform. Alternatively, the type of ink cartridge IC may be determined by the number of times when the output voltage falls below a predetermined reference value and the number of times when the output voltage exceeds a predetermined reference value within a positional range corresponding to one ink cartridge.

(5) In the first embodiment, the ink remaining amount detection processing is performed by comparing the output voltage with the threshold Vthi (see S5 of FIG. 15). However, the ink remaining amount detection processing may performed by comparing the waveform of the output voltage with a reference waveform. Alternatively, the type of ink cartridge IC may be determined by the number of times when the output voltage falls below a predetermined reference value and the number of times when the output voltage exceeds a predetermined reference value within a positional range corresponding to one ink cartridge.

(6) In the first embodiment, the remaining amount estimating unit 160 records an estimated value of the remaining amount of ink in the RAM of the control unit 100, and the semiconductor memory 352 included in an ink cartridge IC. However, the estimated value of the remaining amount of ink may also be recorded in only one of the RAM of the control unit 100, and the semiconductor memory 352 included in an ink cartridge IC.

(7) In the first embodiment, an example has been described, in which the carriage 20 moves on which the holder 21, to which the ink cartridges IC1 to IC4 are detachably mounted, is mounted, and the detection unit 80 is fixed to the body of the printing device 200. However, the present disclosure is not limited to this. The ink cartridges IC1 to IC4 and the detection unit 80 may be configured to be relatively movable. For instance, the carriage on which the detection unit 80 is mounted may move, and the holder 21, to which the ink cartridges IC1 to IC4 are detachably mounted, may be fixed to the body of the printing device 200.

### C2. Another Embodiment 2

In the first embodiment, the first surfaces 391a and the second surfaces 391b of the reflection reduction unit 391 are inclined with respect to the X-axis and to the Z-axis, and parallel to the Y-axis (see FIG. 9). However, the slanted surfaces of the reflection reduction unit may be surfaces not parallel to the Y-axis.

### C3. Another Embodiment 3

(1) In the embodiment, the reflection reduction unit 39D (see FIG. 20) serving as a light guiding unit guides most of reflection light of emission light from the light emitting unit 82 in the X-axis positive direction. The reflection reduction unit 39E (see FIG. 21) serving as a light guiding unit guides most of reflection light of emission light from the light emitting unit 82 in the X-axis positive direction and the X-axis negative direction. However, the reflection reduction unit serving as a light guiding unit may be configured to guide light in a direction other than the X-axis direction, such as the Y-axis direction. However, it is preferable not to guide light in the Z-axis negative direction, in other words, the direction in which the light receiving unit 84 is positioned.

(2) In the embodiment, the reflection reduction unit 39D (see FIG. 20) serving as a light guiding unit has a gray color. The reflection reduction unit 39E (see FIG. 21) serving as a light guiding unit has a blue color. However, the reflection reduction unit serving as a light guiding unit may have another color such as a red color or a green color. Alternatively, the reflection reduction unit serving as a light guiding unit may be transparent or semi-transparent.

### C4. Another Embodiment 4

In the embodiment, the reflection reduction unit 39F (see FIG. 22) serving as a diffusion unit absorbs part of the light emitted from the light emitting unit 82 to the reflection reduction unit 39F by fine depressions and projections on the surface, and diffuses the other part of the light in various directions. Either of the ratio of the light to be diffused or the ratio of the light to be absorbed of the light received by the reflection reduction unit serving as a diffusion unit may be greater.

### C5. Another Embodiment 5

In the embodiment, the ink cartridge IC includes the semiconductor memory 352 which stores information such as the remaining amount of ink and an ink color (see FIG. 14). However, the ink cartridge may be configured not to include a storage unit which stores such information.

In the embodiment, an example has been described, in which the present disclosure is applied to the printing device 200 and the ink cartridge. However, the present disclosure may be used a liquid consumption device that ejects or discharges liquid other than the ink, and is applicable to a liquid container that stores such liquid. In addition, the liquid container of the present disclosure is applicable to various liquid consumption devices including a liquid ejection printing head for discharging liquid droplets with very small volumes. The “liquid droplet” refers to the state of the liquid discharged from the liquid consumption devices, and includes droplets leaving a trail in granular form, tear form, and filiform. The “liquid” referred to herein may be a material which can be ejected by a liquid consumption device. For instance, the liquid may have a state in which the substance is in a liquid phase, and includes not only liquid in a liquid state with a high or low viscosity, a flow state, such as sol, gel water, other inorganic solvents, organic solvents, solution, liquid resin, liquid metal (metal melt), and a state of the substance, but also liquid in which particles of functional materials made of solids, such as pigments and metal particles are dissolved, dispersed or mixed in solvents. Typical examples of liquid include ink and liquid crystal as described in the embodiment. Here, the ink includes water-based ink and oil-based ink in general, and various liquid compositions such as gel ink, and hot melt ink. Specific examples of liquid consumption device may include, for instance, a liquid consumption device that ejects liquid including materials as a dispersed or a dissolved form, such as electrode materials and color materials, used for manufacturing liquid crystal displays, electroluminescent (EL) displays, surface emitting displays, and color filters, a liquid consumption device that ejects living organic materials used for biochip manufacturing, and a liquid consumption device, used as a precision pipette, that ejects liquid as a sample. Furthermore, it is possible to adopt a liquid consumption device that ejects lubricating oil with pinpoint to a precision instrument such as a watch and a camera, a liquid consumption device that ejects transparent resin liquid, such as ultraviolet curing resin, onto a substrate for forming a minute hemispherical lens (optical lens) used in an optical communication device, and a liquid consumption device that ejects etching solution, such as acid or alkali solvent, for etching a substrate.

### D. Other Embodiments

The present disclosure is not limited to the embodiments described above, and may be implemented in various forms without departing from the spirit of the disclosure. For instance, the present disclosure may be implemented in the following embodiments. In order to cope with part or all of the problems of the present disclosure or to achieve part or all of the effects of the present disclosure, the technical features in the embodiments corresponding to technical features in the embodiments described hereafter may be substituted, or combined as needed. If technical features are not described as indispensable features in the present description, the technical features may be deleted as needed.

(1) According to an embodiment of the present disclosure, a liquid container is provided. The liquid container is used in a liquid consumption device including a mounting unit replaceably mountable with: a liquid container provided with a prism at a predetermined site and a liquid container not provided with a prism at the predetermined site; a light emitting unit that emits light to the predetermined site of the liquid container; and a light receiving unit that receives light reflected from the predetermined site. The liquid container is a liquid container not provided with the prism, and a reflection reduction unit that reduces reflection of light to the light receiving unit is provided at the predetermined site.

Let a first type liquid container be a liquid container provided with a prism, and a second type liquid container be a liquid container provided with a reflection reduction unit. The liquid container in this configuration is a second type liquid container. The liquid container in this configuration has compatibility with the first type liquid container. The first type liquid container and the liquid container in this configuration may be mounted to a liquid container mounting unit of a liquid consumption device to which the liquid container in this configuration is applied. In the first type liquid container provided with the prism at a predetermined site, detection characteristics having distinctive peaks are obtained in the light reflected from the predetermined site to the light receiving unit. In contrast, in the liquid container in this configuration provided with the reflection reduction unit at a predetermined site, the amount of light travelling from the predetermined site to the light receiving unit is significantly small. Thus, the detection characteristics obtained from the liquid container in this configuration do not include the distinctive peaks obtained from the first type liquid container, or may include the distinctive peaks which are significantly small. In other words, according to this configuration, the detection characteristics obtained from the first type liquid container and the detection characteristics obtained from the second type liquid container may be made significantly different. Consequently, it is possible to distinguish between the first type liquid container and the second type liquid container. When a liquid container mounted to the mounting unit thereof in a liquid consumption device can be determined to be the first type liquid container or the second type liquid container, it is possible to determine and manage the remaining amount of liquid according to the type of the liquid container.

(2) In the liquid container of the embodiment, a configuration may be adopted in which assume X-axis, Y-axis, and Z-axis are three axes orthogonal to each other, and the prism in the liquid container provided with the prism includes a reflection surface inclined with respect to the Z-axis and to the Y-axis, and parallel to the X-axis, the reflection reduction unit includes one or more slanted surfaces, and the one or more slanted surfaces may be inclined with respect to the Z-axis and to the X-axis, and parallel to the Y-axis. In such a configuration, the light emitted from the light emitting unit to the reflection reduction unit is reflected by the slanted surface of the reflection reduction unit, and the light can be directed in a direction different from the direction in which the light receiving unit is positioned.

(3) In the liquid container of the embodiment, a configuration may be adopted in which assume X-axis, Y-axis, and Z-axis are three axes orthogonal to each other, and the prism in the liquid container provided with the prism includes a reflection surface inclined with respect to the Z-axis and to the Y-axis, and parallel to the X-axis, the reflection reduction unit includes a light guiding unit that guides light in a direction parallel to the X-axis. Also in such a configuration, the light emitted from the light emitting unit to the reflection reduction unit can be directed by the light guiding unit in a direction different from the direction in which the light receiving unit is positioned. Thus, the light which travels to the light receiving unit may be reduced.

(4) In the liquid container of the embodiment, a configuration may be adopted in which the reflection reduction unit includes a light diffusion unit that diffuses the light emitted to the reflection reduction unit or a light absorbing unit that absorbs the light emitted to the reflection reduction unit. In such a configuration, the light which travels to the light receiving unit may be reduced.

(5) According to another embodiment of the present disclosure, a liquid consumption device is provided. The liquid consumption device includes: a mounting unit to which a liquid container is replaceably mounted; a light emitting unit that emits light to a predetermined site of the liquid container mounted to the mounting unit; a light receiving unit that receives light reflected from the predetermined site and that outputs a signal according to the received light; a container determining unit that, based on the signal outputted by the light receiving unit, determines whether the liquid container mounted to the mounting unit is: a first type liquid container including a prism at the predetermined site or a second type liquid container including, at the predetermined site, a reflection reduction unit the reduces reflection of the received light; and a residual determining unit that determines a residual state of the liquid in the liquid container mounted in the mounting unit: utilizing the prism when the container determining unit determines that the liquid container mounted to the mounting unit is the first type liquid container and utilizing information recorded in the second type liquid container, the liquid consumption device, or both when the container determining unit determines that the liquid container mounted to the mounting unit is the second type liquid container.

In the liquid consumption device in this configuration, the first type liquid container may be mounted to the mounting unit or the second type liquid container may be mounted to the mounting unit. In the first type liquid container provided with the prism at a predetermined site, detection characteristics having distinctive peaks are obtained in the light reflected from the predetermined site to the light receiving unit. In contrast, in the second type liquid container provided with the reflection reduction unit at a predetermined site, the amount of light travelling from the predetermined site to the light receiving unit is significantly small. Thus, the detection characteristics obtained from the second type liquid container do not include the distinctive peaks obtained from the first type liquid container, or may include the distinctive peaks which are significantly small. In other words, the detection characteristics obtained from the first type liquid container and the detection characteristics obtained from the second type liquid container are significantly different. Therefore, it is possible to determine that a liquid container is the first type liquid container or the second type liquid container. For the first type liquid container provided with the prism, it is possible to determine a residual state of the liquid utilizing the prism. For the second type liquid container provided with the reflection reduction unit instead of the prism, it is possible to appropriately determine a residual state of the liquid by utilizing information recorded in the second type liquid container, the liquid consumption device, or both. Thus, with the liquid consumption device in this configuration, it is possible to determine the type of liquid container, and determine and manage a residual state of the liquid according to the type of the liquid container.

(6) According to another embodiment of the present disclosure, a method of controlling the liquid consumption device is provided. The liquid consumption device includes: a mounting unit to which a liquid container is mounted; a light emitting unit that emits light to a predetermined site of the liquid container mounted in the mounting unit; and a light receiving unit that receives light reflected from the predetermined site. It is determined based on the signal outputted according to light received by the light receiving unit, whether the liquid container mounted to the mounting unit is: a first type liquid container including a prism at the predetermined site or a second type liquid container including, at the predetermined site, a reflection reduction unit that reduces reflection of the received light; when the liquid container mounted to the mounting unit is determined to be the first type liquid container, a residual state of the liquid is determined utilizing the prism; and when the liquid container mounted to the mounting unit is determined to be the second type liquid container, a residual state of the liquid is determined utilizing information recorded in the second type liquid container, the liquid consumption device, or both.

In the liquid consumption device to which a control method in this configuration is applied, the first type liquid container may be mounted to the mounting unit or the second type liquid container may be mounted to the mounting unit. In the first type liquid container provided with the prism at a predetermined site, detection characteristics having distinctive peaks are obtained in the light reflected from the predetermined site to the light receiving unit. In contrast, in the second type liquid container provided with the reflection reduction unit at a predetermined site, the amount of light travelling from the predetermined site to the light receiving unit is significantly small. Thus, the detection characteristics obtained from the second type liquid container do not include the distinctive peaks obtained from the first type liquid container, or may include the distinctive peaks which are significantly small. In other words, the detection characteristics obtained from the first type liquid container and the detection characteristics obtained from the second type liquid container are significantly different. Therefore, it is possible to determine that a liquid container is the first type liquid container or the second type liquid container. For the first type liquid container provided with the prism, it is possible to determine a residual state of the liquid utilizing the prism. For the second type liquid container provided with the reflection reduction unit instead of the prism, it is possible to appropriately determine a residual state of the liquid by utilizing information recorded in the second type liquid container, the liquid consumption device, or both. Thus, with the control method in this configuration, it is possible to determine the type of liquid container, and determine and manage a residual state of the liquid according to the type of the liquid container.

The present disclosure may be implemented in various forms other than a liquid container, a liquid consumption device, and a method of controlling the liquid consumption device. For instance, the present disclosure may be implemented in various forms, such as a method of manufacturing a liquid container and a liquid consumption device, a method of controlling a liquid container and a liquid consumption device, a computer program that implements the control method, and a non-transitory recording medium on which the computer program is recorded.

Not all of multiple components of the embodiments of the present disclosure described above are required, and in order to cope with part or all of the above-mentioned problems or to achieve part or all of the effects described in the present description, part of the multiple components may be changed, deleted, replaced with other new components, or imposed conditions may be partially deleted as needed. In order to cope with part or all of the above-mentioned problems or to achieve part or all of the effects described in the present description, an independent embodiment of the present disclosure may be implemented by combining part or all of the technical features included in an embodiment of the present disclosure described above with part or all of the technical features included in another embodiment of the present disclosure described above.

What is claimed is:

1. A liquid container which is not provided with a prism used in a liquid consumption device including:
a mounting unit replaceably mountable with:
a liquid container provided with a prism at a predetermined site and
a liquid container not provided with a prism at the predetermined site;
a light emitting unit that emits light to the predetermined site of the liquid container; and
a light receiving unit that receives light reflected from the predetermined site, the liquid container comprising:
a reflection reduction unit that reduces reflection of light to the light receiving unit at the predetermined site.

2. The liquid container according to claim 1, wherein assuming
X-axis, Y-axis, and Z-axis are three axes orthogonal to each other, and
the prism in the liquid container provided with the prism includes a reflection surface inclined with respect to the Z-axis and to the Y-axis, and parallel to the X-axis,
the reflection reduction unit includes one or more slanted surfaces, and
the one or more slanted surfaces are inclined with respect to the Z-axis and to the X-axis, and parallel to the Y-axis.

3. The liquid container according to claim 1, wherein assuming
X-axis, Y-axis, and Z-axis are three axes orthogonal to each other, and
the prism in the liquid container provided with the prism includes a reflection surface inclined with respect to the Z-axis and to the Y-axis, and parallel to the X-axis,
the reflection reduction unit includes a light guiding unit that guides light in a direction parallel to the X-axis.

4. The liquid container according to claim 1, wherein the reflection reduction unit includes a light diffusion unit that diffuses light emitted to the reflection reduction unit or a light absorbing unit that absorbs the light emitted to the reflection reduction unit.

5. A liquid consumption device comprising:
a mounting unit to which a liquid container is replaceably mounted;
a light emitting unit that emits light to a predetermined site of the liquid container mounted to the mounting unit;
a light receiving unit that receives light reflected from the predetermined site and that outputs a signal according to the received light;
a container determining unit that, based on the signal outputted by the light receiving unit, determines whether the liquid container mounted to the mounting unit is:
a first type liquid container including a prism at the predetermined site or
a second type liquid container including, at the predetermined site, a reflection reduction unit that reduces reflection of the received light; and
a residual determining unit that determines a residual state of liquid in the liquid container mounted in the mounting unit:
utilizing the prism when the container determining unit determines that the liquid container mounted to the mounting unit is the first type liquid container and
utilizing information recorded in the second type liquid container, the liquid consumption device, or both when the container determining unit determines that the liquid container mounted to the mounting unit is the second type liquid container.

6. A method of controlling a liquid consumption device including:
a mounting unit to which a liquid container is mounted;
a light emitting unit that emits light to a predetermined site of the liquid container mounted in the mounting unit; and
a light receiving unit that receives light reflected from the predetermined site,
the method comprising:
based on a signal outputted according to light received by the light receiving unit, determining whether the liquid container mounted to the mounting unit is:
a first type liquid container including a prism at the predetermined site or
a second type liquid container including, at the predetermined site, a reflection reduction unit that reduces reflection of the received light;
when the liquid container mounted to the mounting unit is determined to be the first type liquid container, determining a residual state of liquid by utilizing the prism; and
when the liquid container mounted to the mounting unit is determined to be the second type liquid container, determining a residual state of liquid by utilizing information recorded in the second type liquid container, the liquid consumption device, or both.
